(19) United States
(12) Patent Application Publication
(10) Pub. No.: US 2017/0323049 A1
(43) Pub. Date: Nov. 9, 2017

(54) INTERACTION PARAMETERS FOR THE INPUT SET OF MOLECULAR STRUCTURES

(71) Applicants: INRIA INSTITUT NATIONAL DE RECHERCHE EN INFORMATIQUE ET EN AUTOMATIQUE, Le Chesnay (FR); CENTRE NATIONAL DE LA RECHERCHE SCIENTIFIQUE, Paris (FR)

(72) Inventors: Georgy Cheremovsky, Montbonnot-Saint-Martin (FR); Petr Popov, Meylan (FR); Deorgy Derevyanko, Grenoble (FR); Sergey Grudini, Meylan (FR)

(73) Assignees: INRIA INSTITUT NATIONAL DE RECHERCHE EN INFORMATIQUE ET EN AUTOMATIQUE, Le Chesnay (FR); CENTRE NATIONAL DE LA RECHERCHE SCIENTIFIQUE, Paris (FR)

(21) Appl. No.: 15/529,774

(22) PCT Filed: Nov. 24, 2015
(86) PCT No.: PCT/EP2015/077506

§ 371 Date: May 25, 2017

(30) Foreign Application Priority Data
Nov. 25, 2014 (EP) 14306882.3

(51) Int. Cl. G06F 19/16; G06F 17/16

(52) U.S. Cl. CPC G06F 19/16; G06F 17/16

(57) ABSTRACT

The present invention relates to a method for modeling the geometric structure of the interface of Receptor-Ligand complexes, a method for modeling the interaction between a Receptor and a Ligand in Receptor-Ligand complexes, a method for determining a scoring vector w which is a mathematical vector quantifying and/or qualifying the interaction of a geometric structure of the interface of a Receptor-Ligand complex, a method for determining the binding affinity or binding free energy of a position of a Ligand relative to a Receptor in one or more Receptor-Ligand complexes, and a method for ranking the binding affinity or binding free energy of spatial positions of a Ligand relative to a Receptor in one or more Receptor-Ligand complexes.

The present invention concerns a method for modeling the geometric structure of the interface of Receptor-Ligand complexes, a method for modeling the interaction between a Receptor and a Ligand in Receptor-Ligand complexes, a method for determining a scoring vector w which is a mathematical vector quantifying and/or qualifying the interaction of a geometric structure of the interface of a Receptor-Ligand complex, a method for determining the binding affinity or binding free energy of a position of a Ligand relative to a Receptor in one or more Receptor-Ligand complexes, and a method for ranking the binding affinity or binding free energy of spatial positions of a Ligand relative to a Receptor in one or more Receptor-Ligand complexes. All of these methods comprise one or more steps implemented or assisted by computer. The invention also relates to computer assisted design or representation of molecular structures, and more particularly of molecule interaction. The present invention also relates to any device implementing or helping to implement said methods, i.e. the corresponding software and hardware. The applications of the invention are all those where precise molecular interactions are important or crucial for the performance such as computer-aided drug design, pharmaceutical sciences, medicine, physics, and biology. Furthermore, the invention may present advantages for machine learning applications in computer graphics, computer vision, etc.

The average time required to develop a new active molecule, typically a drug, using the standard experimental analysis method Structure-Analysis-Relationship (SAR) is about 10-15 years with a cost of about $1.2 bin. Structure based drug design (SBDD) reduces drug design period to 7-12 years with a cost of about $1 bin, thus saving both time and money. There are thus huge needs to decrease either the duration to develop a new active molecule, the cost thereof, or even preferably both.

In particular, the invention provides a way to perform fast, accurate and efficient virtual screening of potential drug molecules, which is the initial step of the drug design pipeline.

Given a complex of interacting molecules, it is technically difficult to quantify the interaction between the interacting molecules, ideally corresponding to the experimental values of the binding free energy or the binding affinity. It is thus very difficult to predict the binding affinity of a receptor-ligand complex, and thereby difficult to rank and select the best (minimal) binding free energy or the binding affinity in order to select the best candidate(s) for drug design. There is a need to overcome such technical problems.

Despite the vast variety of the methods to obtain the scoring functions (SFs), they can be clustered into three major classes: forcefield-based SFs, empirical SFs and statistical SFs.
Forcefield-based (FF) SFs present the score as a decomposition of the free energy into individual physics-based interaction terms such as van der Waals, electrostatics, bond stretching, bending, etc. energies. Classical molecular mechanical force fields such as AMBER or CHARMM are widely used for this purpose. Major challenges of the Forcefield-based SFs are: 1) accounting for the solvent molecules; 2) accounting for entropic effect; 3) and the possibility of decomposing the binding free energy into a linear combination of interaction terms. GOLD::GoldScore and SYBYL::G-Score/D-Score are the forcefield-based SFs evaluated by Cheng et al′. FF scoring functions are also used in DOCK and AutoDock packages. Overall, FF scoring functions have a rather poor performance¹ and there is no rigorous way to adjust weights between different interaction terms.
Empirical SFs are constructed as a weighted sum of terms, such as desolvation, electrostatic interactions, hydrogen bonds, hydrophobic interactions, etc., αᵢ: E=ΣᵢαᵢEᵢ. Then, coefficients αᵢ are tuned to match some experimental data, such as binding affinity, or to attain a minimum of the scoring function on the known native structures. Regression analysis is typically used for these purposes. Empirical scoring functions are much more computationally efficient in comparison with the FF scoring function²: Glide, ICM, LUDI, PLP, ChemScore, X-Score, Surflex, SYBYL/F-Score, MedusaScore, AlScore, SFCscore are some examples of the empirical-based scoring functions. Overall, Empirical SFs perform better compared to FF scoring functions¹ but posses the same problem of adjusting the weights between their interaction terms.
Statistical scoring functions, on the other hand, are based on the observation that the distances between the atoms in experimentally determined structures follow the Boltzmann distribution. More precisely, using ideas from statistical theory of liquids, effective potentials between atoms are extracted using the inverse Boltzmann relation: Eᵢⱼ(r)=k_{B}T ln(Pᵢⱼ(r)/Z), where k_{B}T is the Boltzmann constant, Pᵢⱼ(r) denotes the probability to find two atoms of types i and j at a distance r, and Z denotes the probability distribution in the reference state. The latter is the thermodynamic equilibrium state of the protein when all interactions between the atoms are set to zero. The score of a protein conformation is then given as a sum of effective potentials between all pairs of atoms. Although this concept is old (it originates from the work of Tanaka and Scheraga³, Miyazawa and Jernigan⁴, and Sippl⁵), it is still under debates. Particularly, the computation of the reference state is a challenging problem and only recently some attempts to rigorously justify and compute it have been made. ITScore, PMF, DrugScore, DFIRE, BLEEP, MScore, GOLD/ASP are some knowledge-based scoring functions. GOLD::ASP, DS::PMF, SYBYL::PMF, and DrugScore were evaluated in Cheng et al comparative assessment′. Overall, Statistical SFs are the winners in all types of benchmarks and competitions′, however they typically have thousands of parameters, which are extremely sensitive to the training sets of molecular structures and parameters of the optimization algorithms.

Despite these improvements, there is still a need to discover a new way to perform faster, more accurate and more efficient virtual screening of potential drug molecules.

The invention thus aims to solve the above-described problems.

More precisely, the methods of the invention and the associated algorithms are very fast, robust, general, and stable to noise in initial structures, as verified on a number of different benchmarks. Therefore the present invention represents an important improvement for modeling of geometric structure of an interface of Receptor-Ligand complexes, for modeling an interaction between a Receptor and a Ligand in Receptor-Ligand complexes, for determining a scoring vector quantifying and/or qualifying the interaction of a geometric structure of an interface of a Receptor-Ligand complex, for determining the binding affinity or binding free energy of a position of a Ligand relative to a Receptor in one or more Receptor-Ligand complexes, and for ranking the binding affinity or binding free energy of spatial positions of a Ligand relative to a Receptor in one or more Receptor-Ligand complexes.

The invention is described below in more details.

The invention relates to a method for modeling the geometric structure of the interface of Receptor-Ligand complexes, wherein a first chemical molecule defined as Receptor and a second chemical molecule defined as Ligand, wherein said method comprises the following steps wherein at least one of them is implemented or assisted by computer:

(a) providing a set of Receptors and Ligands from at least one computer database, wherein Receptor-Ligand complexes present an interface comprising different atom types, wherein atom type k is located on the Receptor and atom type I is located on the Ligand interact, k and I varying depending on the atom type;

(b) selecting atoms from at the Receptor-Ligand complexes interface of said Receptors and Ligands;

(c) assigning to each selected atoms an atom type among k and l;

(d) providing for Receptor-Ligand complexes the distances rᵢⱼ between an atom i of a specific atom type k of the Receptor and an atom j of a specific atom type I of the Ligand, wherein i index runs over specific atoms among atom type k, and wherein j index runs over specific atoms among atom type I;

(e) optionally repeating step (c) for all or other atom types k and I;

(f) assigning the distances rᵢⱼ as a function of atom types; and

(g) providing the modeling of the geometric structure of the interface of Receptor-Ligand complexes as a function of distances rᵢⱼ.

In one embodiment, the interface is a set of all atom pairs ij at a distance smaller than the cutoff distance rₘₐₓ such that the first atom i in each pair ij belongs to the receptor and the second atom j in each pair ij belongs to the ligand.

For example the interface is a set of atoms determined using the standard linked-cell algorithm. More precisely, using a grid initialized with atoms of the receptor, atoms of the receptor-ligand interface are selected, in linear time, as those wherein distance rᵢⱼ is less than the cutoff distance.

In one embodiment, Atom types are defined by the classification of all heavy atoms (that is all atoms excluding hydrogens) according to their element symbol, aromaticity, hybridization, and polarity. Sybyl atom types can be used, for example⁶. In this case, the atom types can be computed by Sybyl, OpenBabel or other widely-used molecular software such as DOCK. Alternatively, manual conversion tables are provided in the literature, for example, in the RPluto user guide from the CSD System package.

Receptors and ligands can be represented as a set of discrete interaction sites located at the centers of the atomic nuclei, thereby forming the interacting interface.

All atoms may be divided for example into M atom types according to the properties of corresponding atomic nuclei (element type, charge, hydrophobicity, etc.). Thereby, each atom has the associated position and atom type. Such atoms may also be defined as interaction sites.

These result in total in M×(M+1)/2 pairs of atom types.

Atom types were assigned to the atoms for example according to their surrounding and functional groups they consist in. To do so, it can for example be used the fconv library′ for atom typization, which provides 158 internal atom types. Then, the atom types are clustered into 48 groups by measuring the statistical similarity of pair-distribution functions between different atom types in the training data set. Atom types set used to describe proteins and ligands can be the same, despite the fact that proteins always contain atoms of only some specific types. In one embodiment, the parameterization consists of 48 atom types. More precisely, such atom types are: 17 types for nitrogen, 9 types for oxygen, 8 types for carbon, 4 types for sulfur, 2 types for phosphorus and 8 types for halogens.

Preferably, said geometric structure is defined as a structure vector x comprising as coordinates distances rᵢⱼ as a function of atom types.

In one embodiment, said structure vector x depends on various atom types in the Receptor-Ligand complex and on the distance between various atom types in the Receptor-Ligand complex. This may be obtained according to equation (11):

xₚ^{kl}=∫ᵣ_{₁}^{r}^{₂}nₖₗ(r)ξₚ(r)\sqrt{Ω(r)}dr (1)

In one embodiment, said modeling of the geometric structure of the interface of Receptor-Ligand complexes takes into account inaccuracies in the determination of distances rᵢⱼ. In one embodiment, inaccuracies in the distance rᵢⱼ are taken into account in the method of the invention.

In one embodiment, the modeling of the geometric structure of the interface of Receptor-Ligand complexes as a function of distances rᵢⱼ. is defined by the number densities n^{kl}(r), wherein said number densities n^{kl}(r) is defined as:

$${n}^{kl} ( r ) = {\sum }_{ij} \frac{1}{\sqrt{2 π {σ}^{2}}} {e}^{- \frac{{( r - {r}_{ij} )}^{2}}{2 {σ}^{2}}} , \qquad ( 4 )$$

wherein each distance distribution is represented by a Gaussian centered at rᵢⱼ with the constant variance of σ⁻², and wherein the distance rᵢⱼ is smaller than a determined cutoff distance rₘₐₓ.

In one embodiment, said linear scoring function F is defined by equation (1):

F(n(r))≡F(n¹¹(r), . . . ,n^{kl}(r), . . . ,n^{MM}(r))=Σₖ₌₁^{M}Σₗ₌ₖ^{M}∫₀^{r}^{ₘₐₓ}n^{kl}(r)U^{kl}(r)dr (2)

wherein unknown “scoring potentials” functions U^{kl}(r) can be determined from a training set of native complexes.

Advantageously, the cutoff distance is set between 1 and 20, preferably between 6 and 12 Ångström (Å). Advantageously, the cutoff distance is 10 Ångström (Å).

In one embodiment, the value of σ is assumed to be equal for all types of site-site interactions and determined from the cross-validation procedure.

In one embodiment, additional information is used for more precise parameterization of variance or even instead of the Gaussian approximation in Eq. (4). Such additional information is for example: individual distance distributions, e.g. Debye-Waller factors, molecular dynamics trajectories, etc.

The invention also relates to a method of generating virtual Non-Native Receptor-Ligand complexes, wherein said method comprises the following steps wherein at least one of them is implemented or assisted by computer:

(a) providing a set of Native Receptor-Ligand complexes Pᵢ^{nat} from at least one computer database, wherein Receptor-Ligand complexes present an interface wherein site k of the Receptor and site I of the Ligand interact;

(b) generating D Non-Native Receptor-Ligand complexes Pⱼ^{nonnat}, j=1 . . . D wherein j index runs over generated decoys and D represents the total number of Non-Native Receptor-Ligand complexes generated, wherein Non-Native Receptor-Ligand complexes are generated by moving spatially the Ligand relative to the Receptor or by local deformation along spatial directions from the Native Receptor-Ligand complexes.

In one embodiment, Non-Native Receptor-Ligand complexes Pⱼ^{nonnat} are generated by rolling the Ligand over the surface of the Receptor. For example, this can be performed using the Hex algorithm.

In one embodiment, Non-Native Receptor-Ligand complexes Pⱼ^{nonnat} are generated by the following steps:
Considering a Ligand as a rigid body,
Rotating the Ligand about one or more rotational axes, and
Translating the Ligand along the coordinate axes.

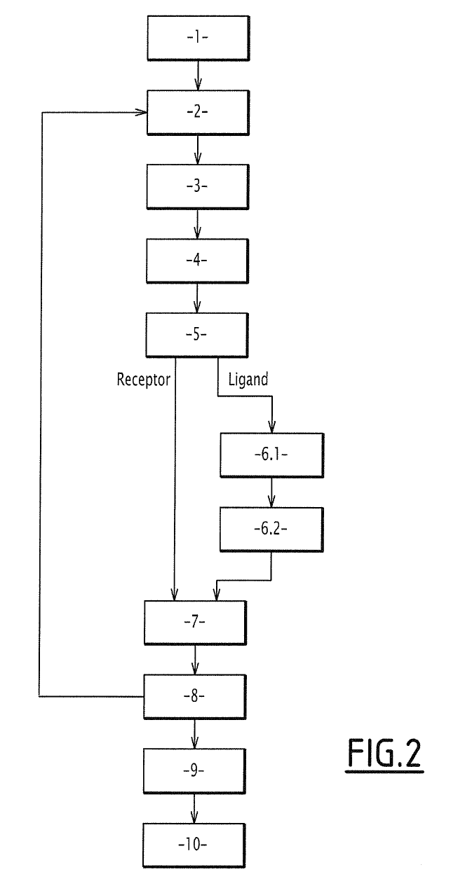

By reference to FIG. 2, it is preferred for small molecules or chemical drug that corresponding decoy is generated by setting axes, for example 6 axes, inside a unit sphere corresponding to its icosahedral tessellation; then by rotating the ligand about these axes such that RMSD is kept constant, and then by setting six translations along the coordinate axes; and translating the ligand by RMSD amount. Small molecules are defined as molecule presenting a molecular weight below 900 Daltons. Small molecules have a size in general of less than 10⁻⁹ m.

In one embodiment, Non-Native Receptor-Ligand complexes Pⱼ^{nonnat} are generated by linear combinations of modes {vᵢ} as follows:

$${X}^{decoy} = {X}^{native} + \sqrt{{k}_{B} T} {\sum }_{i = 6}^{15} {r}_{i} \frac{{v}_{i}}{{ω}_{i}} ,$$

where X^{native} and X^{decoy} are the coordinate vectors corresponding to the native and non-native conformations, respectively, rᵢ is the random weight for each mode ranging from −1 to 1, and ωᵢ is the frequency of the mode vᵢ.

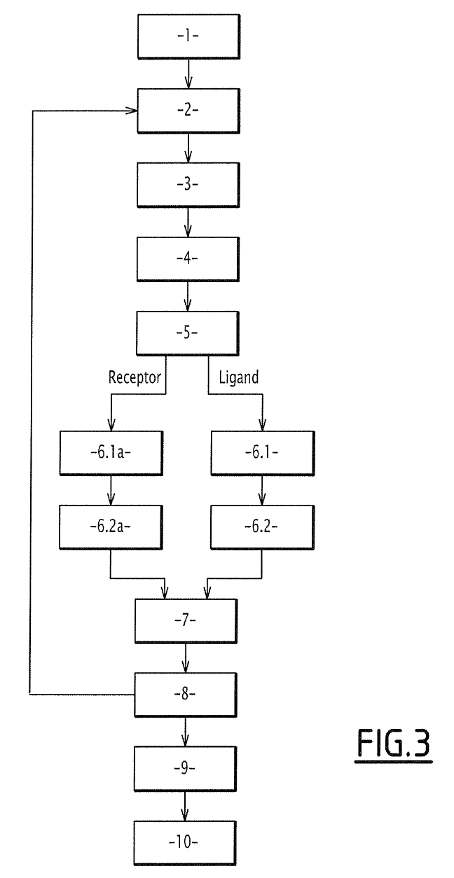

By reference to FIG. 3, it is preferred for Protein-Protein interaction to contract the Hessian Matrix and compute its eigenvectors Lᵢ (for example the 10 first eigenvectors) and then generate decoys (for example 15).

In one embodiment, the modes are obtained by the diagonalization of the Hessian matrix H, which is the matrix of second derivatives of, for example, the OPLS potential function with respect to atomic positions, as H=V ΛV^{T}. Here, V is a unitary matrix, composed of the eigenvectors vᵢ of H and Λ is the diagonal matrix of eigenvalues λᵢ. The frequency and shape of a mode is represented by its eigenvalue and eigenvector, respectively. The frequency of a mode w, is given as the square root of the corresponding eigenvalue, ωᵢ=√λᵢ.

In one embodiment, rolling the Ligand over the surface of the Receptor is performed by the Hex protein docking software⁸

In one embodiment, Receptor-Ligand complex is labeled as “native” if the root mean square deviation (RMSD) of the corresponding Ligand is less than a determined value, for example <2 Å, from its native position. Otherwise, the Receptor-Ligand complex is labeled as “non-native” or “decoy”.

The invention also relates to a method for modeling the interaction between a Receptor and a Ligand in Receptor-Ligand complexes,

wherein said method comprises the following steps wherein at least one of them is implemented or assisted by computer:

(a) providing a set of Receptors and Ligands from at least one computer database;

(b) assigning to each Receptor-Ligand complex a specific structure vector x which is a mathematical vector representing the specific geometric structure of the interface between a Receptor and a Ligand in a specific Receptor-Ligand complex;

(c) computing a linear convex scoring function F as a function of all specific structure vectors x or of vector X which is the concatenation of all vectors x thereof, preferably said linear convex scoring function F being also a function of a scoring vector w;

(d) projecting said scoring function F in orthogonal polynomial subspaces; thereby modeling the interaction between a Receptor and a Ligand in Receptor-Ligand complexes.

According to one embodiment, said method comprises:

(a1) providing a set of Receptor-Ligand complex configuration Pᵢ^{nat}, i=1 . . . N, from at least one computer database, wherein P^{nat} is a native Receptor-Ligand complex configuration and i is an integer assigned to a Receptor-Ligand complex configuration

(a2) calculating a scoring functional F for different Receptor-Ligand complexes wherein for each native complex i and its non-native decoy j the following inequality holds:

F(Pᵢ^{nat})<F(Pᵢⱼ^{nonnat}) (3)

wherein F is a linear convex function depending on the geometrical interface between the Receptor and the Ligand,

wherein Receptors and Ligands are represented as a set of discrete interaction at the interface of the Receptor-Ligand complex(es), and

wherein the interface is a set of all atom pairs at a distance smaller than the cutoff distance rₘₐₓ such that the first atom in each pair belongs to the Receptor and the second atom in each pair belongs to the Ligand.

In one embodiment, F is represented as a function of the distribution of the distances between the atoms of the interface, represented by (3):

F(P)≡F(n¹¹(r), . . . ,n^{kl}(r), . . . ,n^{mm}(r))≡F(n(r)) (4)

wherein n^{kl}(r) is the number density of atom-atom at a distance r between two atom types k and I, with atom type k on the Receptor, and atom type I on the Ligand, where m is the total number of different atoms in a Receptor-Ligand complex interface.

The invention also relates to a method for determining a scoring vector w which is a mathematical vector quantifying and/or qualifying the interaction of a geometric structure of the interface of a Receptor-Ligand complex, wherein Receptor-Ligand complexes present an interface in interaction, wherein said interaction is in need for quantification and/or qualification, wherein said method comprises the following steps wherein at least one of them is implemented or assisted by computer:

(a) providing a set of Receptors and Ligands from at least one computer database;

(b) assigning to each geometric structure of an interface of a Receptor-Ligand complex, a specific structure vector x which is a mathematical vector representing the specific geometric structure of the interface;

(c) computing a linear convex scoring function F as a function of all specific structure vectors x and scoring vector w;

(e) projecting said scoring function F in orthogonal polynomial subspaces;

(f) formulating a convex optimization problem;

(g) solving the convex optimization problem thereby determining a scoring vector w.

In one embodiment, said method comprises computing the score of each conformation using the following equation (4):

Score=Eᵢⱼγ^{kl}(rᵢⱼ) (5)

wherein the sum is taken over all pairs of atoms i and j separated by the distance rᵢⱼ smaller than the threshold rₘₐₓ, with atom i of type k on the Receptor, and atom j of type I on the Ligand, and

In one embodiment, functions γ^{kl}(r) are computed as a convolution γ^{kl}=f*U^{kl}.

In one embodiment, functions γ^{kl}(r) are the Gauss transform (5) of the scoring potential U^{kl}(x):

$${ϒ}^{kl} ( r ) = \frac{1}{\sqrt{2 π {σ}^{2}}} {\int }_{0}^{{r}_{max}} {e}^{- \frac{{( x - r )}^{2}}{2 {σ}^{2}}} {U}^{kl} ( x ) dx \qquad ( 6 )$$

In one embodiment, said scoring function F is projected in orthogonal polynomial subspaces.

In a particular embodiment, the polynomial expansion of the scoring functional F(n(r)) is defined by (6):

F(n(r))=Σ_{k,l}^{M}∫₀^{r}^{ₘₐₓ}Σₚ_{₁}Σₚ_{₂}wₚ_{₁}^{kl}xₚ_{₂}^{kl}ξₚ_{₁}(r)ξₚ_{₂}(r)Ω(r)dr (7)

wherein functions ξₚ(r) are orthogonal on the interval [ᵣ₁; r₂] with a nonnegative weight function Ω(r) defined by (7):

∫ᵣ_{₁}^{r}^{₂}ξₚ_{₁}(r)ξₚ_{₂}(r)Ω(r)dr=δₚ_{₁}ₚ_{₂}, (8)

wherein δₚ₁ₚ₂ is the Kronecker delta function, the scoring potentials Uₖₗ(r) and number densities nₖₗ(r) can be expanded on the interval [r₁; r₂] as

Uₖₗ(r)=Σₚwₚ^{kl}ξₚ(r)\sqrt{Ω(r)},rε[r₁;r₂] (9)

nₖₗ(r)=Σₚxₚ^{kl}ξₚ(r)\sqrt{Ω(r)},rε[r₁;r₂] (10)

wherein expansion coefficients wₚ^{kl} and xₚ^{kl} can be determined from the orthogonality condition (7) as

wₚ^{kl}=∫ᵣ_{₁}^{r}^{₂}Uₖₗ(r)ξₚ(r)\sqrt{Ω(r)}dr (11)

xₚ^{kl}=∫ᵣ_{₁}^{r}^{₂}nₖₗ(r)ξₚ(r)\sqrt{Ω(r)}dr (12)

In one embodiment, said polynomial expansion of the scoring functional F is defined by F(n(r))≈Σₖ₌₁^{M}Σₗ₌ₖ^{M}Σₚ^{P}wₚ^{kl}=(w·x), w, xε [symbol] ^{P×M×(M+1)/2} (13):

F(n(r))≈Σₖ₌₁^{M}Σₗ₌ₖ^{M}Σₚ^{P}wₚ^{kl}=(w·x),w,xε [symbol] ^{P×M×(M+1)/2}(13) (13)

wherein the vector w is the scoring vector and the vector x is the structure vector.

wherein [symbol] ^{P×M×(M+1)/2} is a scoring space of a projection from a Receptor-Ligand complex.

In one embodiment, a convex optimization problem is formulated from polynomial expansion of the scoring functional F defined by (12).

More particularly, a smooth convex optimization problem is formulated or a kernelized smooth optimization problem is formulated.

The invention also relates to a method for finding an optimal scoring vector for modeling Receptor-Ligand complex configurations wherein said scoring vector is defined as scoring vector w,

wherein wε [symbol] ^{P×M×(M+1)/2}

and wherein

∀i=1 . . . N,∀j=1 . . . D(xᵢ^{nat}·w)<(xᵢⱼ^{nonnat}·w), (14)

or, equivalently,

∀i=1 . . . N,∀j=1 . . . D([xᵢⱼ^{nonnat}−xᵢ^{nat}]·w)>0), (15)

which defines a set of N×D half-space equations in [symbol] ^{P×M×(M+1)/2} with N parallel separation hyperplanes defined by the normal w.

In such embodiment, finding the scoring vector is equivalent to finding the common normal to the N planes defined by Eq. (14).

In one embodiment, the solution is given by minimizing a smooth and convex function defined by (15):

Minimize(in w,bⱼ)1/2w·w+Loss(w,x,b) (16)

Wherein Loss is a loss function depending on w, x and b,

wherein w is the scoring vector and the vector x is the structure vector defined by (10-11).

Wherein bⱼ are the offset parameters, which determine the offset of the hyperplanes from the origin along the scoring vector w.

In one embodiment, the scoring vector w is a linear combination of the support vectors.

In one embodiment, the invention uses kernelized version of the Smooth Convex Optimization Problem.

In one embodiment, said step (a) comprises providing Native Receptor-Ligand complex Pᵢ^{nat} and Non-native Receptor-Ligand complexes Pᵢₗ^{nonnat}, wherein i index runs over different protein complexes.

In one embodiment, said step (b) comprises implementing a method for modeling the geometric structure of the interface of Receptor-Ligand complexes as defined in the present invention.

In one embodiment, in step (e) orthogonal polynomial subspaces are Rectangular, Legendre, Laguerre or Fourier orthogonal bases.

In one embodiment, step (f) comprises using the artificially generated noise applied to the original input data.

In one embodiment, said noise is represented by the Gaussian distance distribution of the input data having a variance σ where σ is constant and does not depend on the atom type. This noise can be thought as a Gaussian filter applied to the input data if the latter is represented as a 1D signal.

In one embodiment, step (f) comprises formulating a convex optimization problem so as to minimize the convex function.

In one embodiment, step g) (solving the convex optimization problem thereby determining a scoring vector w) comprises implementing at least one solver selected from the group consisting of the coordinate-descent solver, Nesterov descent solver, a stochastic gradient solver, the quasi-Newton family solvers (e.g. BFGS), and any combination thereof.

Preferably, said method further comprises finding the scoring vector w.

The invention also relates to a method for determining the binding affinity or binding free energy of a position of a Ligand relative to a Receptor in one or more Receptor-Ligand complexes, wherein said Receptor-Ligand complex present an interface comprising different atom types, wherein atom type k, located on the Receptor, and atom type I, located on the Ligand, interact, k and I varying depending on the atom type, wherein said method comprises the following steps wherein at least one of them is implemented or assisted by computer:

(i) modeling the geometric structure of the interface of one or more Receptor-Ligand complexes, said modeling being as defined in the present invention;

(ii) assigning to a geometric structure of the interface of Receptor-Ligand complex, a binding affinity or binding free energy by reference to a database, optionally wherein said binding affinity or binding free energy is determined as a scalar product of the structure vector x with the scoring vector w as defined in the method for determining a scoring vector w as defined in the present invention.

The invention also relates to a method for ranking the binding affinity or binding free energy of spatial positions of a Ligand relative to a Receptor in one or more Receptor-Ligand complexes, wherein said method comprises the following steps wherein at least one of them is implemented or assisted by computer:

(i) implementing the method for determining the binding affinity or binding free energy of a position of a Ligand relative to a Receptor in one or more Receptor-Ligand complexes, to determine the binding affinity or binding free energy of two or more spatial positions of a Ligand relative to a Receptor in one or more Receptor-Ligand complexes,

(ii) ranking spatial positions of a Ligand relative to a Receptor based on said binding affinity or binding free energy by providing a strict relationship between a set of spatial positions such that, for any two positions, the first is either ranked higher, ranked lower or ranked equal to the second position if the binding energy of the first position is smaller, equal or higher than the energy of the second position, respectively.

Advantageously, the best spatial position of a Ligand relative to a Receptor in one or more Receptor-Ligand complexes is determined based on the ranking of said binding affinity or binding free energy.

Advantageously, the best binding affinity or free binding energy among several Receptor-Ligand complexes is determined based on the ranking of said binding affinity or binding free energy.

In the past years, a number of methods to derive scoring functions of different types and properties have been proposed as it is described above. Input information for these methods (structural data, statistical data) is taken from the experiments (X-Ray crystallography, NMR, binding affinity measurements, etc.). However, experimental data is always biased towards certain experimental conditions and always contains standard implementation errors of different types. One of the main advantageous distinction of the invention comprises the accounting for experimental error by introducing uncertainties during the training process (as implemented in the statistical kernel). Different type of kernels might be used, for example, the invention may use the Gaussian kernel, which allows to deal with uncertainties in the experimental data by representing these data as a “dome” centered at the exact experimental measures (for example Eq. (23)). Thus, the structure vectors according to the invention built upon the kerneled experimental data are much more robust, meaning that they represent the real, unbiased, data more accurately without statistical bias. As a consequence, the derived scoring function is also robust and steady to the experimental biases, providing better performance compared to the state-of-the-art scoring functions as it is demonstrated in the example below.

The invention also relates to a software for modeling the geometric structure of the interface of Receptor-Ligand complexes, wherein the software is embodied in a computer readable media and when executed said software implements the method for modeling the geometric structure of the interface of Receptor-Ligand complexes according to the invention.

The invention also relates to a software for generating virtual Non-Native Receptor-Ligand complexes, wherein the software is embodied in a computer readable media and when executed said software implements the method for generating virtual Non-Native Receptor-Ligand complexes according to the invention.

The invention also relates to a software for modeling the interaction between a Receptor and a Ligand in Receptor-Ligand complexes, wherein the software is embodied in a computer readable media and when executed said software implements the method for modeling the interaction between a Receptor and a Ligand in Receptor-Ligand complexes according to the invention.

The invention also relates to a software for determining a scoring vector w which is a mathematical vector quantifying and/or qualifying the interaction of a geometric structure of the interface of a Receptor-Ligand complex, wherein the software is embodied in a computer readable media and when executed said software implements the method for determining a scoring vector w which is a mathematical vector quantifying and/or qualifying the interaction of a geometric structure of the interface of a Receptor-Ligand complex according to the invention.

The invention also relates to a software for determining the binding affinity or binding free energy of a position of a Ligand relative to a Receptor in one or more Receptor-Ligand complexes, wherein the software is embodied in a computer readable media and when executed said software implements the method for determining the binding affinity or binding free energy of a position of a Ligand relative to a Receptor in one or more Receptor-Ligand complexes according to the invention.

The invention also relates to a software for ranking the binding affinity or binding free energy of spatial positions of a Ligand relative to a Receptor in one or more Receptor-Ligand complexes, wherein the software is embodied in a computer readable media and when executed said software implements the method for ranking the binding affinity or binding free energy of spatial positions of a Ligand relative to a Receptor in one or more Receptor-Ligand complexes according to the invention.

The invention also relates to a hardware comprising at least one software as described in the present description.

The invention also relates to a system for generating virtual Non-Native Receptor-Ligand complexes, said system comprising means for generating virtual Non-Native Receptor-Ligand complexes according to the invention.

The invention also relates to a system for modeling the geometric structure of the interface of Receptor-Ligand complexes, said system comprising:

(a) means for providing a set of Receptors and Ligands from at least one computer database, wherein Receptor-Ligand complexes present an interface comprising different atom types, wherein atom type k is located on the Receptor and atom type I is located on the Ligand, k and I varying depending on the atom type;

(b) means for selecting atoms from at the Receptor-Ligand complexes interface of said Receptors and Ligands;

(c) means for assigning to each selected atoms an atom type among k and I;

(d) means for providing for Receptor-Ligand complexes the distances rᵢⱼ between an atom i of a specific atom type k of the Receptor and an atom j of a specific atom type I of the Ligand, wherein i index runs over specific atoms among atom type k, and wherein j index runs over specific atoms among atom type I;

(e) optionally means for repeating step (c) for all or other atom types k and I;

(f) means for assigning the distances rᵢⱼ as a function of atom types; and

(g) means for providing the modeling of the geometric structure of the interface of

Receptor-Ligand complexes as a function of distances rᵢⱼ, preferably said geometric structure is defined as a structure vector x comprising as polynomial coefficients of coordinates distances rᵢⱼ as a function of atom types computed in an orthogonal polynomial basis.

The invention also relates to a system for determining a scoring vector w which is a mathematical vector quantifying and/or qualifying the interaction of a geometric structure of the interface of a Receptor-Ligand complex, said system comprising:

(a) means for providing a set of Native Receptor-Ligand complexes Pᵢ^{nat} from at least one computer database, wherein Receptor-Ligand complexes present an interface wherein site k of the Receptor and site I of the Ligand interact; and

(b) means for generating D Non-Native Receptor-Ligand complexes Pⱼ^{nonnat}, j=1 . . . D wherein j index runs over generated decoys and D represents the total number of Non-Native Receptor-Ligand complexes generated, wherein Non-Native Receptor-Ligand complexes are generated by moving spatially the Ligand relative to the Receptor or by local deformation along spatial directions from the Native Receptor-Ligand complexes.

The invention also relates to a system for modeling the interaction between a Receptor and a Ligand in Receptor-Ligand complexes, wherein said system comprises:

(a) means for providing a set of Receptors and Ligands from at least one computer database;

(b) means for assigning to each Receptor-Ligand complex a specific structure vector x which is a mathematical vector representing the specific geometric structure of the interface between a Receptor and a Ligand in a specific Receptor-Ligand complex;

(c) means for computing a linear convex scoring function F as a function of all specific structure vectors x or of vector X which is the concatenation of all vectors x thereof, preferably said linear convex scoring function F being also a function of a scoring vector w; and

(d) means for projecting said scoring function F in orthogonal polynomial subspaces; thereby modeling the interaction between a Receptor and a Ligand in Receptor-Ligand complexes.

The invention also relates to a system for determining a scoring vector w which is a mathematical vector quantifying and/or qualifying the interaction of a geometric structure of the interface of a Receptor-Ligand complex, wherein said system comprises:

(a) means for providing a set of Receptors and Ligands from at least one computer database;

(b) means for assigning to each geometric structure of an interface of a Receptor-Ligand complex, a specific structure vector x which is a mathematical vector representing the specific geometric structure of the interface;

(c) means for computing a linear convex scoring function F as a function of all specific structure vectors x and scoring vector w;

(e) means for projecting said scoring function F in orthogonal polynomial subspaces;

(f) means for formulating a convex optimization problem; and

(g) means for solving the convex optimization problem thereby determining a scoring vector w.

The invention also relates to a system for determining the binding affinity or binding free energy of a position of a Ligand relative to a Receptor in one or more Receptor-Ligand complexes, wherein said system comprises:

(i) means for modeling the geometric structure of the interface of one or more Receptor-Ligand complexes, said modeling being as defined according to the present invention;

(ii) means for assigning to a geometric structure of the interface of Receptor-Ligand complex, a binding affinity or binding free energy by reference to a database, optionally wherein said binding affinity or binding free energy is determined using a scoring vector w as defined in the method for determining a scoring vector w which is a mathematical vector quantifying and/or qualifying the interaction of a geometric structure of the interface of a Receptor-Ligand complex.

The invention also relates to a system for ranking the binding affinity or binding free energy of spatial positions of a Ligand relative to a Receptor in one or more Receptor-Ligand complexes, wherein said system comprises:

(i) means for implementing the method of determining the binding affinity or binding free energy of a position of a Ligand relative to a Receptor in one or more Receptor-Ligand complexes according to the present invention to determine the binding affinity or binding free energy of two or more spatial positions of a Ligand relative to a Receptor in one or more Receptor-Ligand complexes, and

(ii) means for ranking a set of positions of a Ligand relative to a Receptor by providing a strict relationship between the set such that, for any two positions, the first is either ranked higher, lower or equal to the second position if the said binding free energy of the first position is smaller, equal or higher than the energy of the second position, respectively in one or more Receptor-Ligand complexes according to the present invention to determine the top binding poses of a Ligand relative to a Receptor in one or more Receptor-Ligand complexes.

The invention also relates to the corresponding software and parameter datasets.

The invention also relates to a method for predicting molecule-molecule interactions, for example protein-protein, protein-drug, in particular protein-small molecule interaction, wherein said method comprises implementing at least one method as defined according to the invention.

The invention also relates to a method for designing molecules, for example drugs, proteins, peptides, polypeptides, or other small molecules, wherein said method comprises implementing at least one method according to the present invention.

The present invention has also applications where precise molecular interactions are crucial for the performance such as computer-aided drug design, pharmaceutical sciences, medicine, physics, and biology. Furthermore, the invention relates also to machine learning applications for example in in computer graphics, computer vision, etc.

Currently, the invention provides a solution for companies, especially pharmaceutical companies and organisations working in biological and medical research in general. In particular, the invention provides a way to perform fast, accurate and efficient virtual screening of potential drug molecules, which is the initial step of the drug design pipeline.

The method according to the invention is very fast and general with respect to classes of input molecules.

In the Figures:

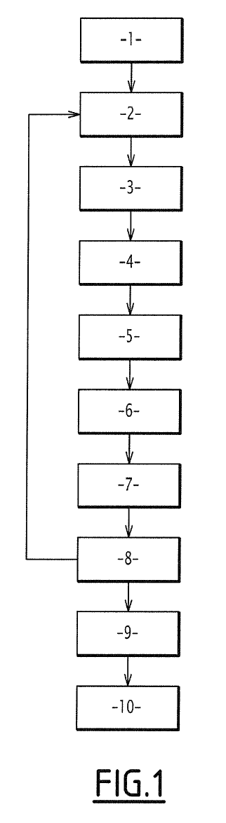

FIG. 1 represents a flowchart of main steps of a method according to the present invention, said method comprising the following steps:

(1) loading of i=1 . . . N structures of native complexes,
(2) performing the following steps (3) to (7) for each complex i:
(3) assigning to each atom the associated atom type;
(4) find all pairs of ligand-receptor atoms separated by less than ten Angstroms,
(5) computing one native structure vector Xᵢ^{nat};
(6) generating decoys;
(7) constructing near-native conformations: for each conformation find all pairs of ligand-receptor atoms separated by less than ten Angstroms;
then,
(8) computing non-native structure vectors Xᵢⱼ^{nonnat};
(9) formulating the optimization problem, given native and non-native structure vectors; and
(10) solving the optimization problem for scoring vectors w.

FIG. 2 is a flowchart representing a method which includes generating decoys for protein-small drug interaction, wherein step (6) of FIG. 1 is further detailed and comprises the following steps for the Ligand (small drug):

(6.1) setting six axes inside a unit sphere corresponding to its icosahedral tessellation, and (6.2) rotating the ligand about these axes such that RMSD is kept constant, and setting six translations along the coordinate axes; and translating the ligand by RMSD amount.

FIG. 3 is a flowchart representing a method which includes generating decoys for protein-protein interaction, wherein step (6) of FIG. 1 is further detailed and comprises the following steps:

For the Ligand: (6.1) constructing the Hessian matrix and computing its eigenvectors Lᵢ, preferably the ten first eigenvectors, and (6.2) then generating decoys X^{decoy} wherein such decoy is defined according to equation (16).

For the receptor: (6.1a) constructing the Hessian matrix and computing its eigenvectors Lᵢ, preferably the ten first eigenvectors, and (6.2a) then generating decoys X^{decoy} wherein such decoy is defined according to equation (16).

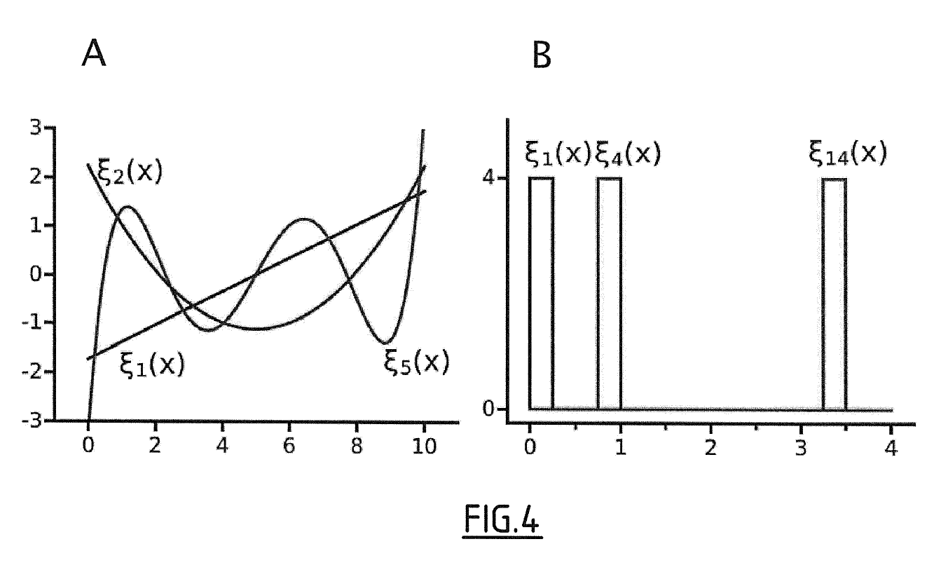

FIG. 4 represents two types of orthogonal functions. Left: shifted Legendre polynomials orthogonal on the interval [0; 10]. Right: shifted rectangular functions.

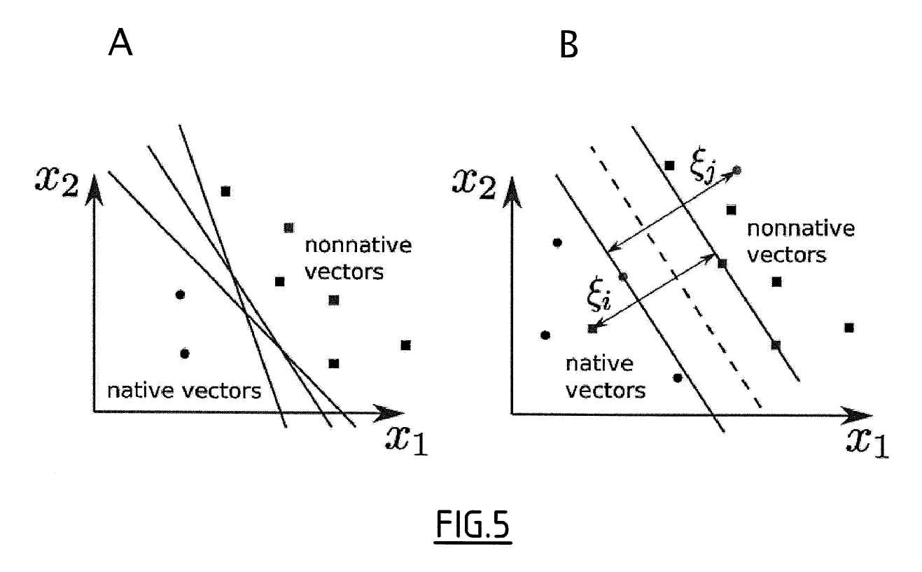

FIG. 5 represents two classes of structure vectors for a single complex. Native structure vectors are plotted as circles. Nonnative structure vectors are plotted as squares. A) The case where infinitely many hyperplanes can separate the two classes. B) The case where no optimal separating hyperplane exists. Slack variables ξᵢ and ξⱼ for misclassified structure vectors are added, which are the distances to the corresponding margin hyperplanes. The optimal hyperplane, which maximizes the separation between the two classes, is plotted as a dashed line. Two margin hyperplanes are plotted as solid lines.

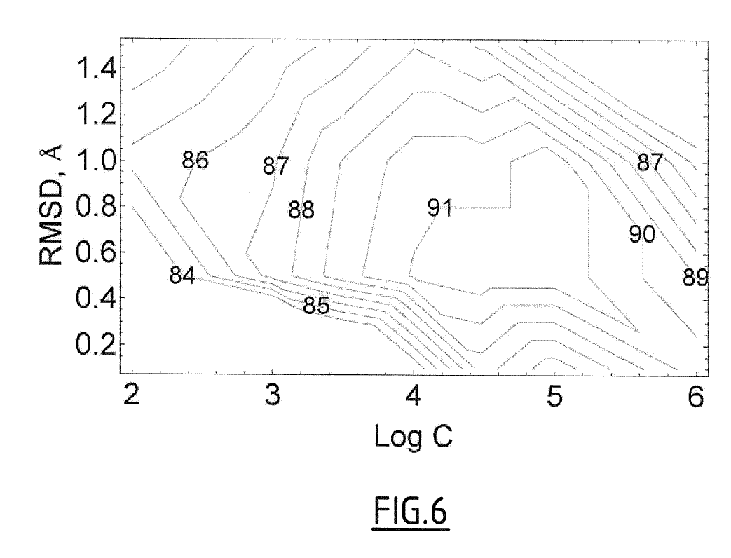

FIG. 6 represents a cross-validation procedure to reveal the optimal RMSD and regularization parameters for the optimization problem for protein-drug interactions.

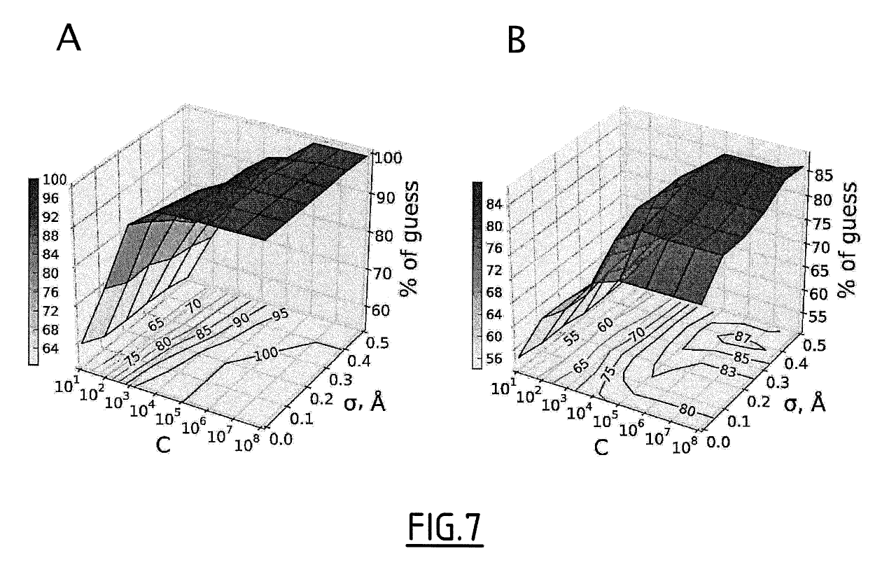

FIG. 7 represents predictive performance of the protein-protein scoring potential as a function of the smoothing parameter a and the regularization parameter C. A) Performance obtained if the scoring functions are trained on the whole database and verified on the same database. B) Performance obtained if the scoring functions are trained on 200 protein complexes and verified on the other 650 complexes from the training database. Here, the best performance is obtained with σ=0 . . . 4 Å and C=10⁶ . . . 10⁷.

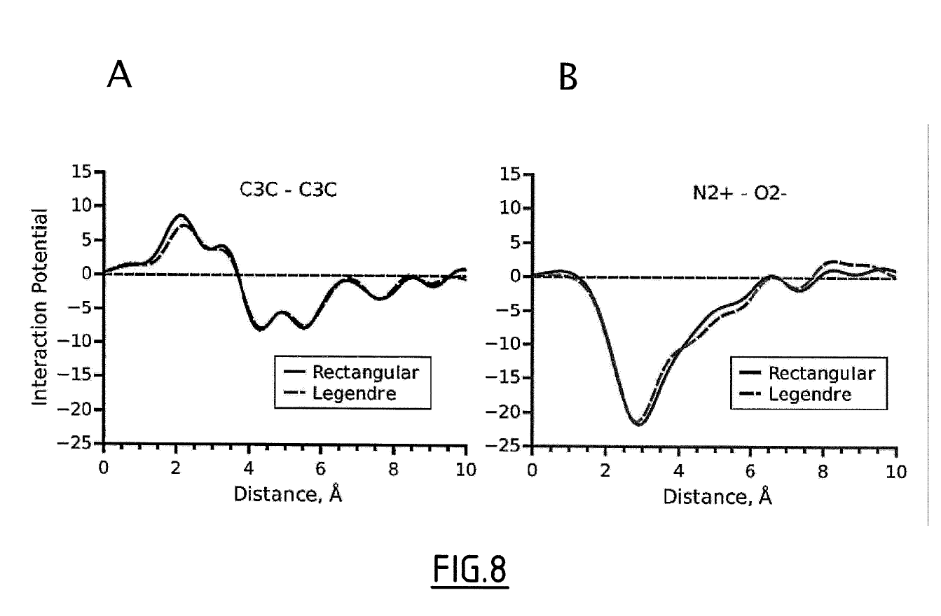

FIG. 8 represents scoring functions trained in two different polynomial bases. Solid lines correspond to the potentials obtained using the rectangular basis functions. Dashed lines correspond to the potentials obtained using the Legendre basis functions. Left: Potential between aliphatic carbons bonded to carbons or hydrogens only. Right: Potential between a guanidine nitrogen with two hydrogens and an oxygen in carboxyl groups.

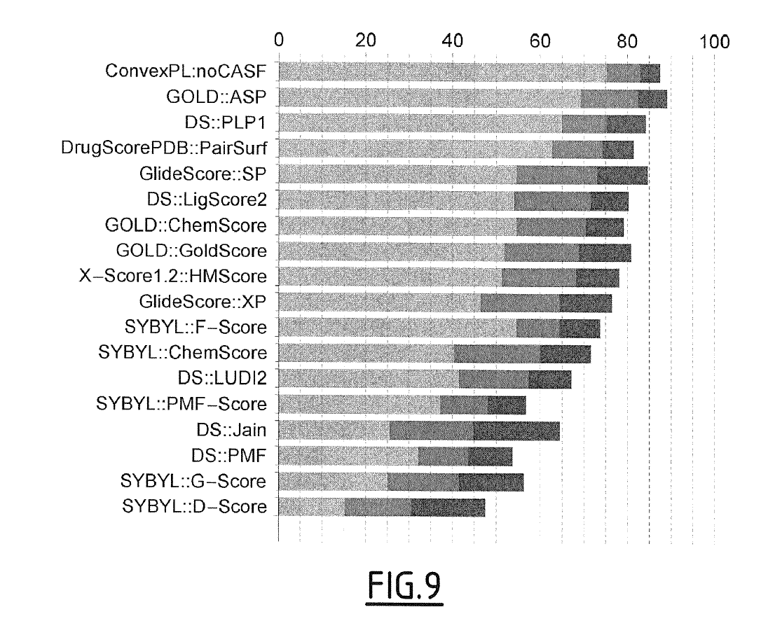

FIG. 9 represents a comparison of the success rates of scoring functions when the best-scored binding pose differs from the true one by RMSD <1.0 Å (light bars)<2.0 Å (darker bars) or <3.0 Å (the darkest bars), respectively. Scoring functions are ranked by success rates when the ligand binding pose is found within RMSD <2.0 Å.

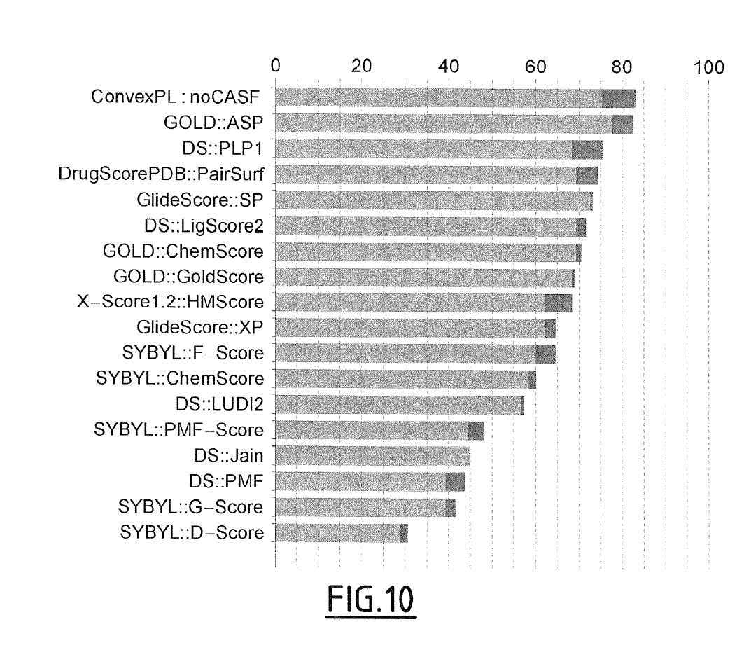

FIG. 10 represents a comparison of the success rates of scoring functions for the cases when the native binding pose is included (dark bars) or not-included (light bars) into the assessment. The acceptance cutoff RMSD is 2.0 Å. Scoring functions are ranked by the darker bars.

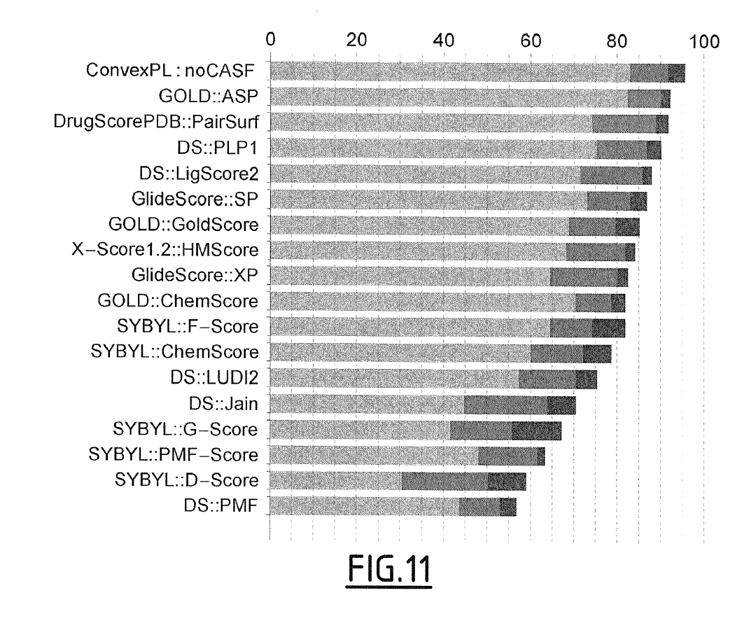

FIG. 11 represents a comparison of the success rates of scoring functions when a ligand binding pose is found within RMSD <2.0 Å from the true one if the top one (light bars), the top two (darker bars), or the top three (the darkest bars) best-scored binding poses are considered. Scoring functions are ranked by success rates when the top three binding poses are considered.

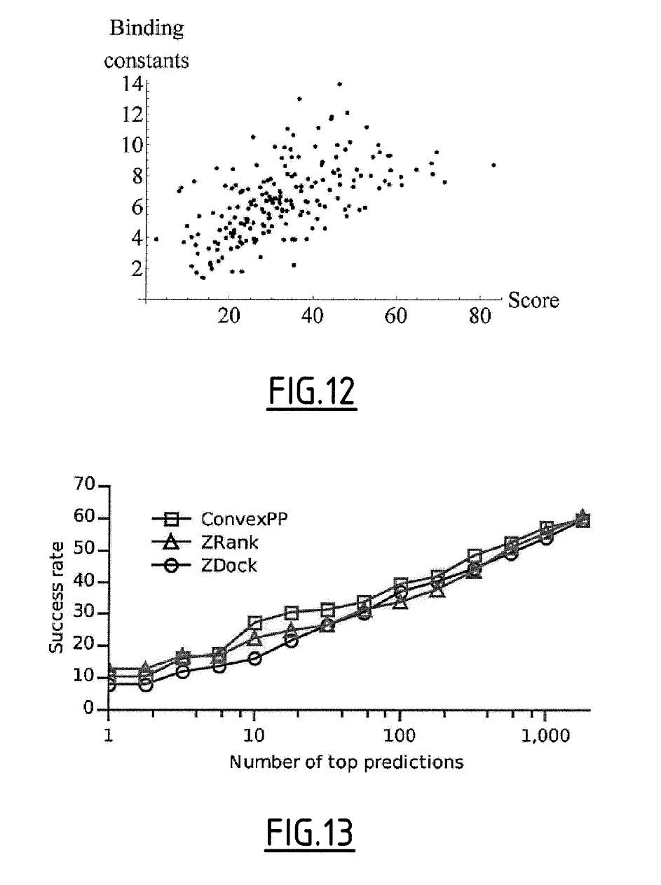

FIG. 12 represents a correlation between experimentally measured binding constants (in −log K_{d} units) of 195 benchmark complexes and the predicted ones. Pearson correlation coefficient is Rₚ=0:59.

FIG. 13 represents a dependence of the success rate on the ZDOCK benchmark on the number of top predictions in consideration for the three methods.

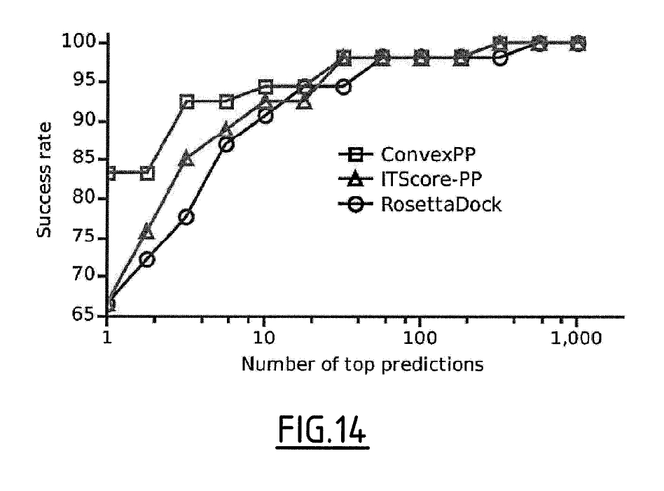

FIG. 14 represents a dependence of the success rate on the RosettaDock benchmark on the number of top predictions in consideration for the three methods.

The invention is described below according to specific examples.

The methods were implemented using the C++ programming language and compiled using g++compiler version 4.6 with optimization levels −O3 and the clang compiler. The programs was ran on a 64-bit Linux Fedora operating system with Intel(R) Xeon(R) CPU X5650 @ 2.67 GHz and on a 64-bit Mac OS system version 10.9 with Intel(R) Core i7 CPU @ 2.7 GHz.

Example of such method is described below relative to the generation of protein-protein interaction or protein-drug interaction (the drug being a small molecule).

### EXAMPLE 1—GENERATING NON-NATIVE RECEPTOR-LIGAND COMPLEXES Pⱼ^{nonnat}

Consider N native Receptor-Ligand complex (for example a proteins-protein or protein-drug complex) configurations Pᵢ^{nat}, i=1 . . . N. For each Receptor complex number i, D decoys Pᵢⱼ^{nonnat} are generated; j=1 . . . D, where the first index runs over different protein complexes and the second index runs over generated decoys.

### Example 1.1 Protein-Protein Interactions

Given each protein near the equilibrium state, the Hessian matrix of the potential energy was constructed and the Fourier subspace for the reduced-basis normal modes computations was computed. The first low-frequency modes from the Fourier basis were picked up to generate different local flexible deformations of the protein complexes. It was decided to exclude the first six modes corresponding to the rigid body motion. More precisely, fifteen decoys for each protein were formed using the linear combinations of modes {vᵢ} as follows:

$${X}^{decoy} = {X}^{native} + \sqrt{{k}_{B} T} {\sum }_{i = 6}^{15} {r}_{i} \frac{{v}_{i}}{{ω}_{i}} \qquad ( 17 )$$

Although, generally, the temperature factor is individual for each monomer, we kept it constant for all the monomers and chose its best value. To do so, we scanned through several values of the temperature factor, namely, 5; 10; 20; 40; 60 (kcal/mol)_{1/2}, using the cross-validation procedure as detailed below in the text. The temperature factor \sqrt{k_{B}T} affects the amplitude of the deformation, hence, too large temperatures cause a monomer to deform significantly breaking the covalent bonds. To ensure the absence of non-relevant decoy conformations, we measured the RMSD between the native and the decoy structures for each value of \sqrt{k_{B}T}. Table 1 lists corresponding values of RMSD. As one can see, indeed, the vast majority of decoys are within 6 Ångström (Å). RMSD with respect to the corresponding native molecule, which means that the normal mode perturbation of the native state (with a given temperature factor) keeps all decoy conformations near-native. At the last step, decoys were combined from two molecules representing one protein complex, resulted in 15×15=225 decoys. To summarize, five training sets corresponding to different values of the temperature factor \sqrt{k_{B}T} were composed. Each training set contained 844 blocks representing different non-homologous protein complex, and each block consists of one native structure and 225 decoys generated with normal modes (Note: if protein complexes occurred too large for the normal mode analysis they were removed from the training set). Thus, each training set comprised of 844× (225+1)=190744 molecule entries, which we used further to derive the statistical scoring function. Normal modes can be also computed in a simpler way using, e.g. the elastic-network, the Gaussian network model, the rotation-translation of blocks method, etc. These methods describe a protein as a set of particles that are interconnected by a network of elastic springs.

TABLE 1
RMSD corresponded to several temperature factors.

| \sqrt{k_{B}T}, (kcal/mol)^{1/2} | RMSD, Å |
|---|---|
| 5 | 0.507 |
| 10 | 1.015 |
| 20 | 2.034 |
| 40 | 4.058 |
| 60 | 6.083 |

Depending on the level of detail of the model, the particles can correspond to the atoms of the protein, a subset of the atoms, or to representative points such as the center of mass of a residue or a sidechain. The normal modes are then found by diagonalization of the Hessian matrix H, which is the matrix of second derivatives of the potential function with respect to atomic positions, as H= [symbol] ^{T}.

All generated decoys represent near-native protein structures. Indeed, normal mode oscillations were used to locally deform molecules, however, the orientation of molecules with respect to each other is fixed. Since all decoy molecules slightly differ from the native monomers, as verified by their RMSD values (see Table 1), the interaction interfaces of all decoy complexes undergo moderate changes and keep at least some part of the native contacts. Putting all together, the training set was based only on local information about the native interfaces and no other information was used.

### Example 1.2 Protein-Ligand Interactions

Generation of the decoy conformations was carried out in the following way. Ligand molecules were considered as rigid bodies and rotated about some axes such that the RMSD distance is kept fixed. To do so, six axes were chosen inside a unit sphere corresponding to its icosahedral tessellation. The weighted RMSD for a pure rotation about axis n by an angle α of a molecule of total mass M with inertia tensor I is:

$${RMSD}^{2} = \frac{4}{M} {sin}^{2} \frac{α}{2} I ( n ) , \qquad ( 18 )$$

where the ligand molecule is considered as a rigid body, whose inertia tensor relative to the axis n passing through its center of mass is given as:

I(n)=n^{T} In (19)

To obtain a decoy with a certain RMSD from the native structure, the latter was first rotated about each rotational axis by ±α and then translated along coordinate axes by the lengths±RMSD. Thus, for each native structure, 18 decoy conformations were generated, which means that the total amount of the training structural vectors was (18+1)×6004=114,076. In order to determine the optimal value of decoy RMSD, the cross-validation process using the training data was carried out. More precisely, the training data was split into two sets, and Eq. (19) was solved while scanning over different parameters of RMSD and the regularization constant C. FIG. 6 shows the success rates obtained on the second part of the training set. One can see well-distinguished peak of success rate on the 2-fold cross validation test. One can see that in principle, any value of RMSD for decoy generation in [0.2 Å, 1.0 Å] interval can be used, provided the value of the regularization parameter C is chosen correspondingly.

To define types of atoms, one can use Sybyl atom types that are given along with mol2 molecular format and also determined by the OpenBabel molecular library⁹, or a more extended set of types, for example the one provided by the fconv library′.

### EXAMPLE 2—FORMULATING THE OPTIMIZATION PROBLEM

The aim is to find such a scoring functional F, defined for all possible complex structures (the set [symbol] ), such that for each native complex i and its nonnative decoy j the following inequality holds:

F(Pᵢ^{nat})<F(Pᵢⱼ^{nonnat}) (20)

Generally, this is a very difficult problem. However, it can be simplified greatly under certain mild assumptions. In order to simplify it, it is assumed the following:
1. F depends only on the interface between the receptor and the ligand.
2. F depends only on the distribution of the distances between the interaction sites (the number of site pairs at a certain distance),

F(P)≡F(n¹¹(r), . . . ,n^{kl}(r), . . . ,n^{mm}(r))≡F(n(r)), (21)

where n^{kl}(r) is, as previously defined, number density functions. For homogeneous systems, such as liquids, functions n^{kl}(r) can be expressed via site-site radial distribution functions g^{kl}(r), which can be obtained experimentally, as n^{kl}(r)=4πr²ρg^{kl}(N), where ρ is the number density and N is the total number of atoms in the system. However, for proteins and small molecules this is not the case.
3. F is a linear functional,

F(αnₜ(r)+βn₂(r))=αF(n₁(r))+βF(n₂(r)) (22)

One of the simplest functionals F(n(r)) fulfilling these assumptions can be written as:

F(n(r))≡F(n¹¹(r), . . . ,n^{kl}(r), . . . ,n^{MM}(r))=Σₖ₌₁^{M}Σₗ₌ₖ^{M}∫₀^{r}^{ₘₐₓ}n^{kl}(r)U^{kl}(r)dr (23)

It contains unknown functions U^{kl}(r) that can be determined from the training set of native complexes. These functions are defined as scoring potentials. Once the scoring functions are known, to compute the value of F, it is needed to specify site-site number densities n^{kl}(r). In practice, they can be calculated as the sum of all k-l distances in a given protein complex taking into account possible inaccuracies in structure determination via:

$${n}^{kl} ( r ) = {\sum }_{ij} \frac{1}{\sqrt{2 π {σ}^{2}}} {e}^{- \frac{{( r - {r}_{ij} )}^{2}}{2 {σ}^{2}}} , \qquad ( 24 )$$

where each distance distribution is represented by a Gaussian centered at rᵢⱼ with the standard deviation of σ. It was assumed that the standard deviation is independent of atom types and thus constant. The sum is taken over all k-l site pairs i and j separated by the distance rᵢⱼ smaller than a certain threshold rₘₐₓ, with site k on the receptor, and site 1 on the ligand. In the limiting case of standard deviation tending to zero, Eq. (23) turns into a sum over Dirac delta functions. In the present invention the value of a is assumed to be equal for all types of site-site distributions. However, if one has an additional information about individual distance distributions, e.g. Debye-Waller factors, molecular dynamics trajectories, etc., it can be used for a more precise parameterization of standard deviation or even instead of the Gaussian approximation in Eq. (23). Finally, the score of each conformation was computed using the following equation:

Score=Σᵢⱼγ^{kl} (25)

where the sum is taken over all pairs of atoms i and j separated by the distance rᵢⱼ smaller than the threshold rₘₐₓ, with atom i of type k on the receptor, and atom j of type 1 on the ligand. The function γ^{kl}(r) is the Gauss transform of the scoring potential U^{kl}(x):

$${ϒ}^{kl} ( r ) = \frac{1}{\sqrt{2 π {σ}^{2}}} {\int }_{0}^{{r}_{max}} {e}^{- \frac{{( x - r )}^{2}}{2 {σ}^{2}}} {U}^{kl} ( x ) dx \qquad ( 26 )$$

More generally, if the distance distributions have a non-Gaussian shape, n^{kl}(r)=Σᵢⱼf(r−rᵢⱼ), functions γ^{kl}(r) will be computed as a convolution γ^{kl}=f*U^{kl}.

2.1 Polynomial Expansions

Given a set of functions ξₚ(r) orthogonal on the interval [r₁; r₂] with a nonnegative weight function Ω(r) such that

∫ᵣ_{₁}^{r}^{₂}ξₚ_{₁}(r)ξₚ_{₂}(r)Ω(r)dr=δₚ_{₁}ₚ_{₂}, (27)

where δₚ_{₁}ₚ_{₂} is the Kronecker delta function, the scoring potentials Uₖₗ(r) and the number densities nₖₗ(r) can be expanded on the interval [r₁; r₂] as

Uₖₗ(r)=Σₚwₚ^{kl}ξₚ(r)\sqrt{Ω(r)},rε[r₁;r₂] (28)

nₖₗ(r)=Σₚxₚ^{kl}ξₚ(r)\sqrt{Ω(r)},rε[r₁;r₂] (29)

Expansion coefficients wₚ^{kl} and xₚ^{kl} can be determined from the orthogonality condition (7) as

wₚ^{kl}=∫ᵣ_{₁}^{r}^{₂}Uₖₗ(r)ξₚ(r)\sqrt{Ω(r)}dr (30)

xₚ^{kl}=∫ᵣ_{₁}^{r}^{₂}nₖₗ(r)ξₚ(r)\sqrt{Ω(r)}dr (31)

Using expansions (8) and (9), the functional F(n(r)) can be rewritten as

F(n(r))=Σ_{k,l}^{M}f₀^{r}^{ₘₐₓ}Σₚ_{₁}Σₚ_{₂}Wₚ_{₁}^{kl}xₚ_{₂}^{kl}(r)ξₚ_{₂}(r)Ω(r)dr (32)

The present invention was demonstrated using two types of functions ξₚ(r) orthogonal on the interval [0; 10] with a unit weight, (i) shifted Legendre polynomials and (ii) traditionally used shifted rectangular functions. These two types of functions are plotted in FIG. 4.

Other types of orthogonal functions (such as Fourier, Legendre, Hermite or Laguerre) can also be used. If the functions ξₚ(r) are chosen to be negligibly small outside the interval [0; rₘₐₓ] or if their interval of orthogonality [r₁; r₂] coincides with the interval [0; rₘₐₓ], as is the case for two sets of the functions according to the invention, then the scoring functional F(n(r)) can be expanded up to some order P as

F(n(r))≈Σₖ₌₁^{M}Σₗ₌ₖ^{M}Σₚ^{p}wₚ^{kl}xₚ^{kl}=(w·x),w, xε [symbol] ^{P×M×(m+1)/2} (33)

It is referred the vector w as the scoring vector and the vector x as the structure vector. Formulas (23) and (30) provide a projection from a protein complex structure into the scoring space [symbol] ^{P×M×(M+1)/2} Using these formulas one can project structural information of each protein complex into a certain structure vector x on [symbol] ^{P×M×(M+1)/2}.

2.2 Problem Formulation

Using the expansion of the scoring functional F provided by Eq. (32), one can reformulate the initial scoring problem (19) as follows: given N native structure vectors xᵢ^{nat} and N×D nonnative structure vectors xᵢⱼ^{nonnat}, find a scoring vector wε [symbol] ^{P×M×(m+1)/2} such that:

∀i=1 . . . N,∀j=1 . . . D(xᵢ^{nat}·w)<(xᵢⱼ^{nonnat}·w), (34)

or equivalently,

∀i=1 . . . N,∀j=1 . . . D([xᵢⱼ^{nonnat}−xᵢⱼ^{nat}]·w)>0), (35)

which is a set of N× D half-space equations in [symbol] ^{P×M×(M+1)/2} with N parallel separation hyperplanes defined by the normal w. Thus, finding the scoring vector is equivalent to finding the common normal to the N planes defined by Eq. (34).

In the training set, some decoy structures can be very close to the native structures. In practice, the native structure is defined as a structure with ligand root-mean-square deviation (L_{RMSD}) smaller than a certain threshold distance. Therefore, for each complex, one may have several native structure vectors along with several nonnative structure vectors. Now the question is: how the set of separating hyperplanes shown with common normal w in FIG. 4 is determined? To answer this question it was first considered two special cases presented below.

2.2.1 Case I. Existence of Many Solutions

FIG. 5A is an example of a single complex where infinitely many hyperplanes can separate two classes of structure vectors. A similar example can be easily constructed for the case with multiple complexes. In case of two classes of vectors, Vapnik proposed to use a special kind of separator, the so-called optimal separating hyperplane¹⁰, which is unique and maximizes the distance to the closest point from either class. The following quadratic programming optimization problem was formulated according to the present invention:

Minimize(in w,bⱼ)1/2w·w

Subject to yᵢⱼ[w·xᵢⱼ−bⱼ]−1≧0,i=1 . . . N,j=1 . . . D (36)

where yᵢⱼ=−1, when the structure vector x₁₁ is native and yᵢⱼ=1 in the other case. Then Lemma 1 is formulated:

Lemma 1 If exists such a linear scoring functional of form (32) that correctly discriminates the native structure vectors for all complexes (equation 34), then the optimal scoring vector is unique and given by the solution of problem (35).

The scoring vector is optimal in the sense that it maximizes the separation between native and nonnative structure vectors.

Generally, such a linear scoring functional (with a fixed value of the expansion order P) may not exist, as demonstrated below. Therefore, the optimization problem (35) has to be modified.

2.2.2 Case II. No Solution Exists

FIG. 5B represents an example where no hyperplane can separate the two classes of the structure vectors of a single complex. For this case, Cortes and Vapnik proposed to relax the condition for the optimal separating hyperplane¹¹, including an additional term, which is often referred as loss function,

Minimize(in w,bⱼ)1/2w·w+Loss(w,x,b) (37)

This term can have a general form, however, for practical applications, it is always chosen as a convex function. In the original formulation, this term minimizes the sum of penalties for misclassified vectors. For each decoy set j=1 . . . D slack variables ξᵢⱼ have been introduced and are positive for misclassified structure vectors and zero otherwise. A non-zero value of allows the structure vector xᵢⱼ to overcome the inequality condition in Eq. (35) at the cost proportional to the value of ξᵢⱼ (see FIG. 5B). The new soft-margin quadratic optimization problem then reads:

$$Minimize ( in w , {b}_{j} , {ξ}_{ij} ) \text{:} \frac{1}{2} w \cdot w + {\sum }_{ij} {C}_{ij} {ξ}_{ij} \\ Subject to \text{:} {y}_{ij} [ w \cdot {x}_{ij} - {b}_{j} ] - 1 + {{ξ}_{ij} \geq 0}_{{ξ}_{ij} \geq 0} , \\ i = 1 … N , j = 1 … D \qquad ( 38 )$$

The solution of this problem provides a trade-off between how large will be the separation between two classes of the structure vectors of each complex and how many misclassified vectors will be in the solution. Parameters Cᵢⱼ can be regarded as regularization parameters. The solution of Eq. (37) tends to maximize the structure vector separation for small values of Cᵢⱼ and minimize the number of misclassified structure vectors for large values of Cᵢⱼ. Parameters Cᵢⱼ have been chosen to be different for native and nonnative structure vectors of each complex because fewer native structure vectors should have a larger weight. The following lemma provides the foundation for the numerical scheme used in this work:

Lemma 2 The optimal scoring vector is unique and given by the solution of problem (37).

Here, the scoring vector is optimal in the sense that it maximizes the separation between native and nonnative structure vectors and minimizes the number of misclassified vectors. Regularization parameters Cᵢⱼ in (37) tune the importance of either factors.

The proof of lemmas (1,2) can be found, e.g., in¹². Overall, the formulation of the optimization problem (37) is very similar to the formulation of the soft-margin support vector machine (SVM) problem¹¹. Therefore, to solve problem (37), techniques developed for SVM have been used.

### EXAMPLE 3—SOLVING THE OPTIMIZATION PROBLEM

Properties and solutions of quadratic optimization problems similar to the one stated above (37) have been extensively studied in the theory of convex optimization. They can be solved in dual and primal forms. For instance, using the Lagrangian formalism, the optimization problem (37) can be converted into its dual form, and the resulting dual optimization problem is convex:

$$Maximize ℒ ( {λ}_{ij} ) : ℒ ( {λ}_{ij} ) = {\sum }_{ij} {λ}_{ij} - \frac{1}{2} {\sum }_{ij} {\sum }_{kl} {y}_{ij} {y}_{kl} {λ}_{ij} {λ}_{kl} {x}_{ij} \cdot {x}_{kl} \\ Subject to \text{:} 0 \leq {λ}_{ij} \leq {C}_{ij} \\ {\sum }_{j} {y}_{ij} {λ}_{ij} = 0 , ∀ ki , \qquad ( 39 )$$

where the maximization is performed with respect to the Lagrange multipliers λᵢⱼ. This dual problem is similar to the the soft-margin SVM optimization problem¹¹. Vectors xᵢⱼ for which λᵢⱼ>0 are called support vectors. Once the dual problem (38) is solved and the Lagrange multipliers λᵢⱼ are found, one can express the solution of the original primal problem (37) (the scoring vector) as a linear combination of the support vectors:

W=Σ_{support vectors}γᵢⱼλᵢⱼxᵢⱼ (40)

The problem formulation according to the invention reduces the amount of RAM required by the solver by N² times.

Therefore, this represents an important technical advantage.

### EXAMPLE 4—GENERATING PROTEIN-PROTEIN COMPLEXES

Hex protein docking software has been used.

Initialized Hex exhaustive search algorithm with the radial search step of 1.5 Å and expansion order of the shape function equal to 31 has been used. One may use only the shape complementarity energy function from Hex (i.e. electrostatic contribution was omitted). The top 200 clusters, ranked by Hex surface complementarity function, plus the native protein-protein complex conformation (giving in total 201 structures) were then used to evaluate the distance distribution functions (23). Then, the structure vectors using Eq. (30) were computed and labeled as “native” if the root mean square deviation (RMSD) of the corresponding ligand was <2 Å from its native position. Otherwise, the structure vector was labeled as “nonnative” or “decoy”. On average, about 2.5 native structure vectors (and, correspondingly, about 198.5 nonnative structure vectors) per protein-protein complex were obtained. To each structure vector xᵢⱼ a regularization parameter Cᵢⱼ was assigned according to

Cᵢⱼ^{native}=CDⱼ^{nonnative}/Dⱼ,

Cᵢⱼ^{nonnative}=CDⱼ^{native}/Dⱼ(41)

where D₁ is the total number of structure vectors for each protein-protein complex (201 in our case), Dⱼ^{native} is the number of native structure vectors for complex j and Dⱼ^{nonnative} is the number of nonnative structure vectors for complex j. The same procedure was respected for each protein-protein complex from the training database. In this example, M=20 atom-centered interaction sites based on the atom types definitions provided by Huang and Zou¹³. These atom types were defined by the classification of all heavy atoms in 20 standard amino acids according to their element symbol, aromaticity, hybridization, and polarity. These 20 atom types result in total of M×(M+1)=210 pair potentials. The training set has several proteins homologous to the ones from the two widely used docking benchmarks, Rosetta, and Zdock, which were used below to validate the results of the invention. Two protein complexes were defined to be homologous if for each chain in the first complex there is a chain in the second complex with sequence identity more than 60%. We determined the sequence identity using FASTA36 program.

### EXAMPLE 5—GENERATING PROTEIN-DRUG COMPLEXES

PDBBind database¹⁴ provides experimentally measured binding affinity data for the complexes deposited in the Protein Data Bank. The “general set” of release PDBBind 2011 contains binding data (K_{d}, Kᵢ & IC50 values) and three-dimensional structures of resolution equal to or better than 2.5 Å for 6051 protein-ligand complexes. This information was used in order to derive the scoring function for protein-drug interactions.

### EXAMPLE 6—TRAINING SET FOR PROTEIN-PROTEIN INTERACTIONS

To predict protein-protein interactions we used the training database of 851 non-redundant protein-protein complex structures collected by Huang and Zou¹³. This database contains protein-protein complexes extracted from the PDB¹⁵ and includes 655 homodimers and 196 heterodimers. Three PDB structures from the original training database were updated: 2Q33 supersedes 1N98, 2ZOY supersedes 1V7B, and 3KKJ supersedes 1YVV. The training database contains only crystal dimeric structures determined by X-ray crystallography at resolution better than 2.5 Å. Each chain of the dimeric structure has at least 10 amino acids, and the number of interacting residue pairs (as defined as having at least 1 heavy atom within 4.5 Å) is at least 30. Each protein-protein interface consists only of 20 standard amino acids. No homologous complexes were included in the training database. Two protein complexes were regarded as homologues if the sequence identity between receptor-receptor pairs and between ligand-ligand pairs was >70%. Finally, Huang and Zou manually inspected the training database and left only those structures that had no artifacts of crystallization.

The algorithm of the invention requires as input native and nonnative structure vectors (see, e.g., equation (14)). Native structure vectors can be computed from the native protein-protein contacts in the training database using equation (11). However, for the computation of the nonnative structure vectors for each protein-protein complex from the training database, decoys were generated for each complex. Since the optimization algorithm of the invention is very general and has no special requirements for nonnative protein-protein contacts, nonnative protein-protein were generated by “rolling” a smaller protein (ligand) over the surface of a bigger protein (receptor) using the Hex protein docking software⁸. To do so, Hex exhaustive search algorithm initialized with the radial search step of 1.5 Å and expansion order of the shape function equal to 31. Only the shape complementarity energy function from Hex (i.e., electrostatic contribution was omitted) was used. The top 200 clusters, ranked by Hex surface complementarity function, plus the native protein-protein complex conformation (giving a total of 201 structures) were then used to evaluate the distance distribution functions (23). Then, the structure vectors using Eq. (11) were computed and labeled according to example 4.

For the optimization of protein-protein interactions, we used the following parameters, σ=0:4 Ångström (Å), C=10⁵. The maximum expansion order P was set to P=40. FIG. 8 shows two examples of the scoring function γ^{kl}(r) (see Eq. (5)).

### EXAMPLE 7—TRAINING SET FOR PROTEIN-DRUG INTERACTIONS

PDBBind database provides experimentally measured binding affinity data for the complexes deposited in the Protein Data Bank. The “general set” of release PDBBind 2011 contains binding data (K_{d}, Kᵢ & IC50 values) and three-dimensional structures of resolution equal to or better than 2.5 Å for 6051 protein-ligand complexes. This information was used in order to derive the scoring function for protein-drug interactions.

Generation of the decoy conformations was carried out in the following way. Ligand molecules were considered as rigid bodies and rotated about some axes such that the RMSD distance is kept fixed. This generation of decoys was performed according to example 5.

For the optimization of protein-drug interactions, the following parameters, were used: σ=0.4 Ångström (Å), C=10⁵ and RMSD=0.6 Ångström (A). The maximum expansion order P was set to P=25.

### EXAMPLE 8—GRADIENT-BASED STRUCTURE OPTIMIZATION

Note that orthogonal polynomials used for the expansion of the scoring potentials (Eq. 8) might be non-smooth functions, e.g. rectangular polynomials. Thus, generally, the scoring potentials Uₖₗ(r) could be not differentiable. However, thanks to the applied Gauss transform, functions γ^{kl}(r) (Eq. (4)) are smooth as a convolution of analytic locally integrable functions. This fact allows extending the functionality of functions γ^{kl}(r) from the scoring to the structure optimization using their first or higher-order derivatives. More accurately, for a given k-l pair of atoms at a distance rᵢⱼ, the negative gradient −∇γ^{kl}(rᵢⱼ) equals to the force acting on the atoms in this pair. Thus, the set of derived functions γ^{kl}(r) could be used in a force-field manner, optimizing the structure of a particular complex until a local minimum is reached, provided ∇γ^{kl}(rᵢⱼ)=0 for each pair of atoms.

Since special calibration of the potential functions is required to retain the structure integrity of a complex, more relevant application would be a rigid-body optimization, where instead of force minimization over each pair of atoms, one minimizes the net force acting on the complex. Thus, at a local minimum, Σ_{k,l}Σ_{i,j}∇γ^{kl}=0 holds. Rigid-body optimization with functions γ^{k}(r) could be useful in a local rigid-body minimization as a refinement step to process docking predictions. It was shown that such refinement could improve docking predictions dramatically. By contrast to our functions γ^{kl}(r), most of modern statistical pair-wise potentials are not differentiable (ITScore, DOPE, DFIRE, RAPDF, etc.). Thereby, to perform optimization with such potentials one either smooth them a-posterior, which worsen the potential quality, or uses various derivative-free optimization strategies, e.g. Nelder-Mead or Powell methods and their modifications, where the convergence rate is much slower compared to the first- or higher-order optimization strategies.

### EXAMPLE 9—CROSS VALIDATION STUDIES

To tune free regularization parameters C and σ, and also the value of the RMSD parameter used during decoy generation, we carried out a series of cross-validation computational experiments, where we split the training dataset into two parts following the training on the first part and validation on the second part. Results of the cross-validation for protein-protein interactions are shown in FIG. 7. Here, the best performance is achieved with α=0.4 Å, and C=10⁵ . . . 10⁶. Results of the cross-validation for protein-drug interactions are shown in FIG. 6. We can see that the optimum parameters belong to the range of C=10⁴ . . . 10⁶ and RMSD=0.4 . . . 1 Å. For the production run optimization, we used the following parameters, α=0.4 Å, C=10⁵ Å and RMSD=0.6 Å.

The width of the Gaussian parameter a dictates the number of polynomial coefficients sufficient to encode the shape of the potential. More precisely, we let the maximum expansion order P to be P=rₘₐₓ/σ. Using the values of rₘₐₓ=10 Å and σ=0.4 Å, we concluded that the maximum expansion order is P=25. Using the Legendre polynomial basis, we have numerically verified that higher expansion orders do not contribute to the quality of the reconstructed potentials, provided that the parameters rₘₐₓ and a are kept constant.

### EXAMPLE 10—RANKING OF PROTEIN-PROTEIN AND PROTEIN-DRUG STRUCTURES

If structure optimization is not required, as it happens in scoring of decoys generated by other docking programs, then ranking is performed using Eq. (12). More precisely, for each structure of a protein-protein or a protein-grid complex, one computes the structure vectors xₚ^{kl} using Eq. (11). Then, these structure vectors are multiplied with the pre-computed scoring vectors wₚ^{kl} according to Eq. (12) and a linear approximation of the binding free energy is obtained. Now, structures of the complexes can be ranked according to this free energy approximation. If structure optimization is desired, in practice we use Eqs. (4-5) for the gradient-based structure optimization. During the optimization, the gradient of the scoring function (4) is computed with respect to six rigid-body coordinates of the receptor and the ligand. Then, the structure is iteratively optimized until a certain convergence is achieved. Finally, different structures are ranked according to the scores of the optimized binding poses.

Here one should note that the binding free energy F and the binding affinity terms are synonymous. Both are connected to the experimentally measured dissociation constant Kd as F=RT log Kd/c, where R is the ideal gas constant, T is temperature and the standard reference concentration c=1 mol/L.

### EXAMPLE 11—RESULTS FOR PROTEIN-DRUG INTERACTIONS

11.1 Docking Power

The first general method of assessment of a scoring function is to see how well it can predict the true binding pose. More precisely, if the best ranked ligand pose is close enough (within RMSD range of 1.0, 2.0 or 3.0 Å) to the known true one, the scoring function is said to guess it correctly within a certain RMSD threshold. Success rate of the scoring function according to the invention in comparison to the others is shown in FIG. 9. FIG. 10 represents the difference in results, when native conformation is included or excluded from the decoy set. As one can see, the difference is not more than 5% for all the scoring functions, which is not very significant. Therefore, the native pose was included into the decoy sets from the benchmark in order to be able to compare the performance to the results published previously. In the comparisons above, only the best ranked ligand poses were considered. Practically, during prediction of the binding pose, it is appropriate to submit few poses. FIG. 11 shows success rates in cases when one, two or three best ranked poses are considered. For many scoring functions one can notice a significant increase in the prediction power when several poses are considered in comparison to FIG. 9. Another representation of docking power evaluation results that includes success rates of the DSX¹⁶ scoring functions is given in Table 2. Results of DSX cited from¹⁶ and the rest (excluding ConvexPL)—from¹. The last column corresponds to the success rate of finding the top ranked ligand pose within RMSD≦2.0 Å from the crystallographically determined one, when this true one is excluded from the decoy set.

ConvexPL is the scoring function according to the invention.

TABLE 2
Success rates in docking power assessment.

| | Crystal | | | | |
|---|---|---|---|---|---|
| | structure | | | | |
| | on | | ≦2.0 Å pose on | | |
| | Top 1 | Top 5 | Top 1 | Top 5 | Top 1 pose no |
| Scoring function | pose | poses | pose | poses | cryst. |
| ConvexPL | 55.9 | 80.5 | 83.1 | 97.8 | 75.4 |
| DS::Jain | 1.5 | 15.4 | 44.8 | 79.2 | 44.8 |
| DS::LigScore2 | 17.9 | 49.7 | 71.6 | 92.9 | 69.4 |
| DS::LUDI2 | 9.7 | 29.2 | 57.4 | 83.6 | 56.8 |
| DS::PLP1 | 40.5 | 75.9 | 75.4 | 97.3 | 68.3 |
| DS::PMF | 19.5 | 44.1 | 43.7 | 67.2 | 39.3 |
| DrugScoreCSD::Pair | 50.3 | 79.5 | 58.5 | 94.0 | 25.7 |
| DrugScoreCSD::PairSurf | 44.6 | 80.0 | 54.1 | 95.6 | 25.1 |
| DrugScorePDB::Pair | 40.0 | 73.8 | 74.3 | 93.4 | 68.9 |
| DrugScorePDB::PairSurf | 39.5 | 74.9 | 74.3 | 95.1 | 69.4 |
| DrugScorePDB::Surf | 3.6 | 20.0 | 32.8 | 80.3 | 32.2 |
| DSX^{PDB}::PairSR | 51.8 | 77.9 | 84.7 | 95.6 | 78.7 |
| DSX^{CSD}::All | 52.8 | 77.9 | 85.2 | 96.2 | 79.2 |
| GOLD::ASP | 36.9 | 71.8 | 82.5 | 95.6 | 77.6 |
| GOLD::ChemScore | 17.9 | 50.8 | 70.5 | 86.9 | 69.4 |
| GOLD::GoldScore | 8.2 | 28.7 | 68.9 | 89.6 | 68.3 |
| GlideScore::SP | 18.5 | 50.3 | 73.2 | 93.4 | 72.7 |
| SYBYL::F-Score | 21.5 | 49.2 | 64.5 | 90.7 | 60.1 |
| X-Score1.2 | 32.3 | 64.6 | 67.2 | 91.3 | 63.4 |
| X-Score1.2::HMScore | 30.3 | 57.9 | 68.3 | 90.7 | 62.3 |

11.2. Scoring Power

The second evaluation criterion for a scoring function is how well it can predict the binding affinity of a protein-drug complex. Table 3 shows the correlations between true binding constants (K_{d}) and the binding scores obtained with the scoring function, which corresponds to Table 2 from¹.

The problem of predicting correct binding affinity and the next one, ligand ranking, are far more challenging problems, than ligand docking. There is a correlation between the size of a ligand (the number of heavy atoms—NHA in Table 3) and its binding affinity. For the test set, the value of the Pearson correlation for the function according to the invention (“ConvexPL”) is 0.431. Such a simple measure as ligand size provides a better correlation coefficient than some of scoring functions. Even scoring functions that show the best results in docking power do not achieve high correlations between binding scores and true binding affinities. And vice versa, if a function shows good correlation, it could still achieve modest results in docking.

As mentioned above, the test set is highly diverse there is a big difference between the highest and the lowest binding affinity of complexes included in the set, as it is evident from FIG. 10. Probably this is one of the reasons of such moderate success rates of all the scoring functions, and if one considers only particular family of protein ligand complexes, better results can be achieved. See¹ and their additional test sets.

The presence of 195 test protein-ligand complexes in the training sets can be an issue for some functions. To assess it, the success rates were provided when the test set is included to the training set or excluded from it in Table 3 for ConvexPL and X-Score (version with excluded test set is named 1.3) The best three results are shown by empirical-based X-Score, the knowledge-based DSXCSD::All and ConvexPL.

TABLE 3
Correlations between the experimentally measured binding constants and
the binding scores

| Scoring function | Rₚ | Rₛ |
|---|---|---|
| X-Score::HMScore | 0.644 | 0.705 |
| DSXCSD::All | 0.609 | — |
| ConvexPL | 0.591 | 0.648 |
| ConvexPL (test set excluded) | 0.587 | 0.642 |
| DSXPDB::PairSR | 0.571 | — |
| DrugScoreCSD | 0.569 | 0.627 |
| SYBYL::ChemScore | 0.555 | 0.585 |
| DS::PLP1 | 0.545 | 0.588 |
| GOLD::ASP | 0.534 | 0.577 |
| SYBYL::G-Score | 0.492 | 0.536 |
| DS::LUDI3 | 0.487 | 0.478 |
| DS::LigScore2 | 0.464 | 0.507 |
| GlideScore-XP | 0.457 | 0.435 |
| DS::PMF | 0.445 | 0.448 |
| GOLD::ChemScore | 0.441 | 0.452 |
| NHA | 0.431 | 0.517 |
| SYBYL::D-Score | 0.392 | 0.447 |
| DS::Jain | 0.316 | 0.346 |
| GOLD::GoldScore | 0.295 | 0.322 |
| SYBYL::PMF-Score | 0.268 | 0.273 |
| SYBYL::F-Score | 0.216 | 0.243 |

11.3 Ranking Power

Finally, the last assessment criterion for a scoring function, studied by¹ is the ligand ranking power. Let's consider a given protein target and a list of ligand molecules. Cheng, et al. define the ranking power of a scoring function as the ability to correctly rank the known ligands bound to a common target by their binding affinities when their true binding modes are known.

Table 4 shows the success rates of several scoring functions. The best four functions for ranking are X-Score, DSXCSD::All, DS::PLP2, ConvexPL. Success rates of these top functions are comparable to the success rates in the scoring power assessment. This fact seems interesting, because one could expect that the ligand ranking is an easier problem than scoring. Again, the best results are achieved by the empirical-based function as X-Score and DS::PLP2. Excluding the 195 test complexes from the training set of the function according to the invention leads to the improvement of the success rate by about 1.6% (ConvexPL test set excluded).

TABLE 4
Success rates in the ligand ranking assessment.

| Scoring function | Success rate % |
|---|---|
| X-Score::HSScore | 58.5 |
| DSXCSD::All | 55.4 |
| DS::PLP2 | 53.8 |
| ConvexPL (test set excluded) | 52.3 |
| DSXPDB::PairSR | 52.3 |
| DrugScoreCSD | 52.3 |
| ConvexPL | 50.7 |
| SYBYL::ChemScore | 47.7 |
| SYBYL::D-Score | 46.2 |
| SYBYL::G-Score | 46.2 |
| GOLD::ASP | 43.1 |
| DS::LUDI3 | 43.1 |
| DS::Jain | 41.5 |
| DS::PMF | 41.5 |
| SYBYL::PMF-Score | 38.5 |
| GOLD::ChemScore | 36.9 |
| DS::LigScore2 | 35.4 |
| GlideScore-XP | 33.8 |
| NHA | 32.3 |
| SYBYL::F-Score | 29.2 |
| GOLD::GoldScore | 23.1 |

Parameters obtained with the invention outperform all academic and industrial scoring functions (35 different in total) as presented on FIGS. 9, 10 and 11. The present invention also ensures not only a superb predictive power of docking poses, but also a very good correlation between the scores and the binding affinity data

### EXAMPLE 12—RESULTS FOR PROTEIN-PROTEIN INTERACTIONS

12.1 ZDOCK Benchmark

We tested the ConvexPP scoring function on the protein-protein docking benchmark version 3.0. It consists of 124 crystallographic structures of protein-protein complexes extracted from the PDB database¹⁷. These are divided into three groups: rigid, medium and difficult cases. The division criteria is the scale of conformational changes of the proteins upon binding: from minor changes in rigid cases to the major ones in difficult cases. The non-redundancy of the benchmark was set at the level of family-family pairs.

The decoys for the scoring were generated using ZDOCK 3.0 with the sampling step equal to 6 degrees. We call this set of docking position ZDOCK benchmark. The docking program ZDOCK 3.0 generates the rigid-body protein-protein docking predictions with the corresponding scores. Scoring function used in this program includes shape complementarity, statistical pair potentials and electrostatics. ZRANK is the program for reranking the ZDOCK3.0 predictions. In addition to the factors used in ZDOCK3.0, it computes detailed electrostatics, estimates desolvation and uses additional Van-der-Waals potential to re-score the decoys. The benchmark 3.0 has several complexes homologous to certain protein complexes in the training set. Therefore, we trained our potential both excluding homologs from the training set and leaving it unchanged. Table 5 shows results of ZDOCK3.0, ZRANK and our scoring functions on the ZDOCK3.0 benchmark.

2000 decoys generated by ZDOCK3.0 were ranked with the original ZDOCK function, ZRANK and the scoring potentials according to the invention. A hit is a predicted near-native decoy with I_{RMSD} less than 2.5 Å. The I_{RMSD} parameter is the RMSD of the interface region between the predicted and native structures after optimal superimposition of the backbone atoms of the interface residues. A residue is considered as the interface residue if any atom of this residue is within 10 Å from the other partner. The number of hits when only the top one prediction considered (Top1) obtained by ZRANK is higher than the one obtained by ConvexPP potentials (15 vs 12 hits). Although if top 10 predictions were considered, the scoring function according to the invention outperforms ZRANK (32 vs 26 hits). Excluding homologs from the training set results in a slight improvement of the results (Table 5).

Table 5: ZDock benchmark 3.0 results. Three scoring functions are compared, ZDock, ZRank, and ConvexPP. Proteins homologous to the ones in the training set are shown in bold. Absence of hits among the first 2000 predictions is shown with hyphens. The I_{RMSD} parameter represents the quality of a pose, which is the RMSD of the backbone atoms of the ligand after the receptors in the native and the decoy conformations have been optimally superimposed. The IRMSD parameter is the RMSD of the interface region between the predicted and native structures after optimal superimposition of the backbone atoms of the interface residues. A residue is considered as the interface residue if any atom of this residue is within 10 Å from the other partner. The fnat parameter is the ratio of the number of native residue-residue contacts in the predicted complex to the number of residue-residue contacts in the crystal structure.

TABLE 5
ZDock benchmark 3.0 results

| | ZDock | | | | ZRank | | | | ConvexPP | | | |
|---|---|---|---|---|---|---|---|---|---|---|---|---|
| Complex | Rank | L_{RMSD} | I_{RMSD} | fₙₐₜ | Rank | L_{RMSD} | I_{RMSD} | fₙₐₜ | Rank | L_{RMSD} | I_{RMSD} | fₙₐₜ |

Rigid-Body

| | | | | | | | | | | | | |
|---|---|---|---|---|---|---|---|---|---|---|---|---|
| 1AHW | 54 | 8.30 | 1.58 | 0.60 | 175 | 2.68 | 1.26 | 0.72 | 547 | 2.14 | 0.91 | 0.79 |
| 1BVK | — | — | — | — | — | — | — | — | — | — | — | — |
| 1DQJ | — | — | — | — | — | — | — | — | — | — | — | — |
| 1E6J | 1 | 3.80 | 1.59 | 0.64 | 12 | 6.06 | 2.35 | 0.40 | 35 | 4.21 | 2.26 | 0.48 |
| 1JPS | 1 | 3.90 | 1.04 | 0.70 | 254 | 4.32 | 1.26 | 0.65 | 62 | 4.14 | 1.11 | 0.78 |
| 1MLC | 5 | 4.61 | 1.14 | 0.36 | 54 | 4.61 | 1.14 | 0.36 | 5 | 4.70 | 1.12 | 0.39 |
| 1VFB | 997 | 10.89 | 2.48 | 0.30 | 798 | 0.89 | 2.48 | 0.30 | 1239 | 10.89 | 2.48 | 0.30 |
| 1WEJ | 2 | 2.44 | 0.79 | 0.91 | 41 | 2.44 | 0.79 | 0.91 | 1 | 4.13 | 1.30 | 0.75 |
| 2FD6 | 15 | 18.67 | 2.42 | 0.73 | 9 | 9.76 | 2.42 | 0.80 | 8 | 15.65 | 2.16 | 0.80 |
| 2I25 | 1534 | 7.92 | 2.21 | 0.36 | 1 | 4.45 | 1.87 | 0.33 | 83 | 4.45 | 1.87 | 0.33 |
| 2VIS | 8 | 27.81 | 2.02 | 0.63 | 150 | 6.31 | 2.18 | 0.57 | 617 | 23.89 | 2.37 | 0.43 |
| 1BJ1 | 19 | 6.29 | 1.19 | 0.62 | 1 | 4.22 | 0.97 | 0.88 | 2 | 2.82 | 0.98 | 0.86 |
| 1FSK | 1 | 2.69 | 1.04 | 0.91 | 3 | 1.39 | 0.65 | 0.93 | 3 | 3.98 | 1.39 | 0.81 |
| 1I9R | 40 | 3.07 | 1.53 | 0.79 | 493 | 3.07 | 1.53 | 0.79 | 462 | 16.85 | 2.30 | 0.48 |
| 1IQD | 169 | 5.25 | 1.01 | 0.60 | 3 | 3.08 | 0.88 | 0.73 | 16 | 4.20 | 0.97 | 0.67 |
| 1K4C | 587 | 7.42 | 1.67 | 0.43 | 1615 | 9.12 | 1.64 | 0.45 | 242 | 5.78 | 1.31 | 0.62 |
| 1KXQ | 14 | 2.04 | 1.28 | 0.70 | 1 | 1.75 | 0.93 | 0.93 | 1 | 3.06 | 1.04 | 0.88 |
| 1NCA | 14 | 2.85 | 0.92 | 0.83 | 150 | 1.75 | 0.97 | 0.76 | 12 | 4.50 | 1.38 | 0.86 |
| 1NSN | 473 | 4.95 | 2.00 | 0.50 | 728 | 2.41 | 1.06 | 0.79 | 636 | 4.95 | 2.00 | 0.50 |
| 1QFW | 192 | 5.05 | 1.24 | 0.71 | 310 | 4.21 | 1.41 | 0.77 | 1315 | 5.12 | 1.35 | 0.73 |
| 1QFW | 192 | 5.05 | 1.24 | 0.71 | 310 | 4.21 | 1.41 | 0.77 | 1315 | 5.12 | 1.35 | 0.73 |
| 2JEL | 1239 | 6.12 | 1.90 | 0.55 | 223 | 6.12 | 1.90 | 0.55 | 957 | 6.83 | 2.30 | 0.31 |
| 1AVX | 11 | 7.49 | 1.61 | 0.56 | 7 | 6.73 | 1.86 | 0.54 | 3 | 4.85 | 2.23 | 0.39 |
| 1AY7 | 74 | 3.82 | 2.13 | 0.52 | 468 | 3.82 | 2.13 | 0.52 | 185 | 5.73 | 1.82 | 0.45 |
| 1BVN | 16 | 2.60 | 1.54 | 0.43 | 1 | 3.74 | 1.85 | 0.46 | 3 | 4.09 | 1.74 | 0.50 |
| 1CGI | 89 | 4.27 | 2.34 | 0.43 | 14 | 4.27 | 2.34 | 0.43 | 61 | 3.20 | 2.30 | 0.49 |
| 1D6R | — | — | — | — | — | — | — | — | — | — | — | — |
| 1DFJ | 2 | 5.12 | 2.08 | 0.55 | 1 | 3.82 | 1.87 | 0.52 | 1 | 5.97 | 2.42 | 0.50 |
| 1E6E | 5 | 2.97 | 2.00 | 0.42 | 15 | 2.98 | 1.72 | 0.53 | 9 | 4.01 | 2.41 | 0.42 |
| 1EAW | 1 | 9.32 | 2.48 | 0.46 | 42 | 9.32 | 2.48 | 0.46 | 1 | 2.60 | 1.03 | 0.70 |
| 1EWY | 21 | 3.16 | 1.74 | 0.56 | 9 | 3.32 | 1.88 | 0.61 | 21 | 3.16 | 1.74 | 0.56 |
| 1EZU | — | — | — | — | — | — | — | — | — | — | — | — |
| 1F34 | 62 | 7.51 | 2.34 | 0.41 | 34 | 5.95 | 2.46 | 0.49 | 38 | 3.41 | 1.45 | 0.54 |
| 1HIA | — | — | — | — | — | — | — | — | — | — | — | — |
| 1MAH | 3 | 2.77 | 1.12 | 0.72 | 1 | 2.77 | 1.12 | 0.72 | 1 | 3.64 | 1.26 | 0.69 |
| 1N8O | 92 | 4.60 | 1.51 | 0.60 | 1 | 5.15 | 1.51 | 0.68 | 1 | 2.94 | 1.24 | 0.74 |
| 1OPH | — | — | — | — | — | — | — | — | — | — | — | — |
| 1PPE | 1 | 1.84 | 0.77 | 0.79 | 1 | 2.25 | 0.86 | 0.83 | 1 | 4.62 | 1.52 | 0.71 |
| 1R0R | 70 | 1.83 | 0.71 | 0.74 | 178 | 1.32 | 0.74 | 0.60 | 2 | 8.36 | 2.46 | 0.40 |
| 1TMQ | 71 | 4.92 | 2.08 | 0.35 | 61 | 3.61 | 1.49 | 0.60 | 8 | 6.11 | 1.97 | 0.45 |
| 1UD1 | — | — | — | — | — | — | — | — | — | — | — | — |
| 1YVB | 38 | 12.34 | 2.32 | 0.54 | 6 | 7.33 | 1.92 | 0.71 | 8 | 7.33 | 1.92 | 0.71 |
| 2B42 | 10 | 6.17 | 1.17 | 0.89 | 1 | 6.17 | 1.17 | 0.89 | 8 | 9.44 | 2.23 | 0.43 |
| 2MTA | 748 | 4.86 | 2.41 | 0.59 | 1352 | 2.96 | 1.81 | 0.59 | 125 | 3.76 | 1.88 | 0.50 |
| 2O8V | — | — | — | — | — | — | — | — | — | — | — | — |
| 2PCC | 920 | 6.29 | 2.19 | 0.44 | 975 | 5.67 | 2.17 | 0.39 | 458 | 6.29 | 2.19 | 0.44 |
| 2SIC | 1 | 6.47 | 1.44 | 0.52 | 3 | 8.89 | 2.40 | 0.43 | 3 | 5.92 | 1.19 | 0.73 |
| 2SNI | 178 | 4.14 | 1.44 | 0.53 | 230 | 6.34 | 2.16 | 0.42 | 8 | 8.57 | 2.45 | 0.57 |
| 2UUY | 22 | 12.46 | 2.11 | 0.74 | 380 | 13.94 | 2.39 | 0.66 | 233 | 13.72 | 2.38 | 0.66 |
| 7CEI | 3 | 4.33 | 1.36 | 0.65 | 1 | 0.68 | 2.44 | 0.44 | 4 | 8.41 | 2.46 | 0.65 |
| 1A2K | — | — | — | — | — | — | — | — | — | — | — | — |
| 1AK4 | — | — | — | — | — | — | — | — | — | — | — | — |
| 1AKJ | 175 | 6.35 | 2.15 | 0.53 | 637 | 4.22 | 1.70 | 0.65 | 395 | 3.30 | 1.54 | 0.60 |
| 1AZS | 123 | 11.64 | 1.86 | 0.69 | 8 | 2.49 | 1.74 | 0.65 | 1 | 11.04 | 1.88 | 0.69 |
| 1B6C | 2 | 7.35 | 2.37 | 0.74 | 1 | 3.47 | 2.38 | 0.87 | 2 | 3.67 | 2.23 | 0.90 |
| 1BUH | 353 | 4.13 | 1.56 | 0.60 | 18 | 3.42 | 1.81 | 0.63 | 1 | 3.42 | 1.81 | 0.63 |
| 1E96 | 24 | 5.56 | 1.99 | 0.54 | 219 | 9.54 | 2.38 | 0.42 | 261 | 6.03 | 2.18 | 0.58 |
| 1EFN | — | — | — | — | — | — | — | — | — | — | — | — |
| 1F51 | 237 | 3.41 | 1.82 | 0.60 | 368 | 3.41 | 1.82 | 0.60 | 16 | 3.41 | 1.82 | 0.60 |
| 1FC2 | — | — | — | — | — | — | — | — | — | — | — | — |
| 1FQJ | — | — | — | — | — | — | — | — | — | — | — | — |
| 1GCQ | 922 | 1.98 | 1.19 | 0.71 | 1171 | 1.98 | 1.19 | 0.71 | 118 | 1.98 | 1.19 | 0.71 |
| 1GHQ | — | — | — | — | — | — | — | — | — | — | — | — |
| 1GLA | 12 | 3.38 | 1.52 | 0.32 | 919 | 3.38 | 1.52 | 0.32 | 57 | 4.91 | 2.22 | 0.37 |
| 1GPW | 1 | 5.05 | 2.03 | 0.58 | 39 | 7.13 | 2.39 | 0.50 | 1 | 7.10 | 2.44 | 0.39 |
| 1HE1 | 43 | 6.92 | 2.20 | 0.47 | 2 | 8.68 | 2.35 | 0.47 | 301 | 5.93 | 1.74 | 0.38 |
| 1I4D | — | — | — | — | — | — | — | — | — | — | — | — |
| 1J2J | 1897 | 5.59 | 2.12 | 0.55 | 277 | 5.59 | 2.12 | 0.55 | 86 | 5.59 | 2.12 | 0.55 |
| 1K74 | 1 | 5.86 | 2.29 | 0.42 | 1 | 6.11 | 2.35 | 0.52 | 8 | 7.90 | 2.02 | 0.48 |
| 1KAC | 11 | 4.47 | 2.07 | 0.40 | 438 | 5.35 | 2.22 | 0.36 | 287 | 4.47 | 2.21 | 0.36 |
| 1KLU | — | — | — | — | — | — | — | — | — | — | — | — |
| 1KTZ | 397 | 6.04 | 1.15 | 0.63 | 1486 | 4.25 | 1.54 | 0.74 | 282 | 5.39 | 1.25 | 0.63 |
| 1KXP | 40 | 4.94 | 1.79 | 0.49 | 1 | 6.29 | 2.09 | 0.46 | 1 | 7.43 | 2.17 | 0.51 |
| 1ML0 | 1 | 2.27 | 1.25 | 0.76 | 1 | 5.05 | 2.07 | 0.51 | 1 | 4.47 | 1.89 | 0.61 |
| 1QA9 | — | — | — | — | — | — | — | — | — | — | — | — |
| 1RLB | 25 | 8.50 | 2.05 | 0.55 | 2 | 9.11 | 1.93 | 0.66 | 7 | 9.11 | 1.93 | 0.66 |
| 1S1Q | 1195 | 2.35 | 1.53 | 0.58 | 420 | 2.35 | 1.53 | 0.58 | 766 | 2.35 | 1.53 | 0.58 |
| 1SBB | — | — | — | — | — | — | — | — | — | — | — | — |
| 1T6B | 351 | 6.12 | 1.49 | 0.52 | 166 | 5.90 | 1.87 | 0.48 | 89 | 5.91 | 2.03 | 0.64 |
| 1XD3 | 135 | 6.68 | 2.21 | 0.55 | 62 | 4.87 | 2.49 | 0.30 | 6 | 4.87 | 2.49 | 0.30 |
| 1Z0K | 19 | 4.60 | 1.99 | 0.74 | 1 | 5.52 | 1.99 | 0.74 | 11 | 4.59 | 1.68 | 0.56 |
| 1Z5Y | 77 | 5.69 | 1.97 | 0.50 | 46 | 5.80 | 2.27 | 0.41 | 8 | 6.58 | 1.97 | 0.50 |
| 1ZHI | 71 | 4.80 | 1.32 | 0.71 | 119 | 8.39 | 1.79 | 0.65 | 78 | 9.90 | 1.96 | 0.61 |
| 2AJF | — | — | — | — | — | — | — | — | — | — | — | — |
| 2BTF | 655 | 5.61 | 2.31 | 0.31 | 398 | 5.61 | 2.31 | 0.31 | 655 | 6.00 | 2.20 | 0.33 |
| 2HLE | 1 | 3.38 | 2.11 | 0.42 | 9 | 5.95 | 2.43 | 0.42 | 9 | 6.84 | 2.35 | 0.35 |
| 2HQS | 1092 | 8.94 | 2.30 | 0.37 | 1162 | 8.94 | 2.30 | 0.37 | 576 | 8.94 | 2.30 | 0.37 |
| 2OOB | — | — | — | — | — | — | — | — | — | — | — | — |

Medium

| | | | | | | | | | | | | |
|---|---|---|---|---|---|---|---|---|---|---|---|---|
| 1BGX | — | — | — | — | — | — | — | — | — | — | — | — |
| 1ACB | — | — | — | — | — | — | — | — | — | — | — | — |
| 1IJK | 444 | 7.43 | 1.65 | 0.31 | 376 | 5.02 | 1.35 | 0.38 | 124 | 6.42 | 1.83 | 0.25 |
| 1KKL | 1002 | 6.23 | 2.50 | 0.44 | 1774 | 6.23 | 2.50 | 0.44 | 325 | 6.23 | 2.50 | 0.44 |
| 1M10 | — | — | — | — | — | — | — | — | — | — | — | — |
| 1NW9 | — | — | — | — | — | — | — | — | — | — | — | — |
| 1GP2 | — | — | — | — | — | — | — | — | — | — | — | — |
| 1GRN | 1365 | 7.10 | 2.49 | 0.00 | 676 | 7.10 | 2.49 | 0.00 | 1785 | 7.10 | 2.49 | 0.00 |
| 1HE8 | — | — | — | — | — | — | — | — | — | — | — | — |
| 1I2M | — | — | — | — | — | — | — | — | — | — | — | — |
| 1IB1 | — | — | — | — | — | — | — | — | — | — | — | — |
| 1K5D | 1111 | 8.04 | 2.03 | 0.29 | 466 | 8.04 | 2.03 | 0.29 | 1185 | 8.04 | 2.03 | 0.29 |
| 1N2C | — | — | — | — | — | — | — | — | — | — | — | — |
| 1WQ1 | — | — | — | — | — | — | — | — | — | — | — | — |
| 1XQS | 314 | 6.91 | 2.47 | 0.34 | 19 | 6.91 | 2.47 | 0.34 | 199 | 5.60 | 2.28 | 0.38 |
| 2CFH | 237 | 5.20 | 2.12 | 0.36 | 1 | 3.83 | 1.86 | 0.47 | 1 | 5.20 | 2.12 | 0.36 |
| 2H7V | 525 | 13.69 | 2.47 | 0.44 | 98 | 3.69 | 2.47 | 0.44 | 8 | 13.69 | 2.47 | 0.44 |
| 2HRK | — | — | — | — | — | — | — | — | — | — | — | — |
| 2NZ8 | — | — | — | — | — | — | — | — | — | — | — | — |

Difficult

| | | | | | | | | | | | | |
|---|---|---|---|---|---|---|---|---|---|---|---|---|
| 1E4K | — | — | — | — | — | — | — | — | — | — | — | — |
| 2HMI | — | — | — | — | — | — | — | — | — | — | — | — |
| 1FQ1 | — | — | — | — | — | — | — | — | — | — | — | — |
| 1PXV | — | — | — | — | — | — | — | — | — | — | — | — |
| 1ATN | — | — | — | — | — | — | — | — | — | — | — | — |
| 1BKD | — | — | — | — | — | — | — | — | — | — | — | — |
| 1DE4 | — | — | — | — | — | — | — | — | — | — | — | — |
| 1EER | — | — | — | — | — | — | — | — | — | — | — | — |
| 1FAK | — | — | — | — | — | — | — | — | — | — | — | — |
| 1H1V | — | — | — | — | — | — | — | — | — | — | — | — |
| 1IBR | — | — | — | — | — | — | — | — | — | — | — | — |
| 1IRA | — | — | — | — | — | — | — | — | — | — | — | — |
| 1JMO | — | — | — | — | — | — | — | — | — | — | — | — |
| 1R8S | — | — | — | — | — | — | — | — | — | — | — | — |
| 1Y64 | — | — | — | — | — | — | — | — | — | — | — | — |
| 2C0L | — | — | — | — | — | — | — | — | — | — | — | — |
| 2OT3 | — | — | — | — | — | — | — | — | — | — | — | — |

| | | | | | | |
|---|---|---|---|---|---|---|
| Homologs | Top1: 8.1% | (10/124) | Top1: 12.9% | (16/124) | Top1: 10.5% | (13/124) |
| included | Top10: 16.1% | (20/124) | Top10: 22.6% | (28/124) | Top10: 27.4% | (34/124) |

| | | |
|---|---|---|
| Homologs | Top1: 12.1% | (15/124) |
| excluded | Top10: 29.0% | (36/124) |

FIG. 13 shows ROC curves (success rate versus the number of top predictions considered). One may see that ConvexPP scoring functions outperform ZRANK and ZDOCK if the number of considered predictions is more than eight.

12.2—Rosetta Benchmark

Baker, Gray et al generated the Rosetta benchmark using 54 complexes of the protein-protein docking benchmark version 0.0¹⁸ using a flexible docking protocol, which is a part of the RosettaDock suite¹⁹. The first step in the protocol is the random translation and rotation of one of the proteins constituting the complex. Afterwards, the side chain is optimized simultaneously with the rigid body displacement. Finally, the full-atom minimization is done to refine the conformation. For each complex, Baker and Gray generated 1000 decoys following the described protocol. The success rate of RosettaDock was calculated using the same quality criteria as in Critical Assessment of PRediction of Interactions²⁰. The Rosetta benchmark contains 5 complexes homologous to the ones present in the training set. Therefore the scoring function according to the invention was trained using training sets with and without these homologs. Table 6 compares the results of RosettaDock¹⁹, ITScore-PP¹³ and our ConvexPP scoring functions.

Table 6 shows that the potentials according to the invention significantly improve

Top1 prediction rate over ITScore-PP and RosettaDock scoring functions while also outperforming them according to the other criteria (Top1 and quality 1 etc.). The percentage of the structures for which the first acceptable prediction was ranked within the top predictions was computed for each complex and plotted on FIG. 14. According to the plot, the scoring function of the invention (ConvexPP) outputs the plausible structure (quality≧3) for more complexes than ITScore-PP and RosettaDock. Unlike the results on the ZDock benchmark, the results on the Rosetta unbound benchmark slightly decrease when homologous complexes were removed from the training set. Among the prediction quality criteria it is the number of predicted high quality structures that changed the most. On the other hand Top1 prediction rate stayed almost the same. This observation means that the number of predicted high-quality structures is amenable to overfitting. Therefore unlike the Top1 criterion, it can not serve as a reliable measure of a scoring function predictive power.

Table 6: Rosetta unbound benchmark results. Proteins homologous to the ones in the training set are shown in bold. The L_{RMSD} parameter represents the quality of a pose, which is the RMSD of the backbone atoms of the ligand after the receptors in the native and the decoy conformations have been optimally superimposed. The I_{RMSD} parameter is the RMSD of the interface region between the predicted and native structures after optimal superimposition of the backbone atoms of the interface residues. A residue is considered as the interface residue if any atom of this residue is within 10 Å from the other partner. The fₙₐₜ parameter is the ratio of the number of native residue-residue contacts in the predicted complex to the number of residue-residue contacts in the crystal structure. To assign the quality for the docking predictions, we use the criterion from Critical Assessment of PRediction of Interactions (CAPRI).

TABLE 6
Rosetta unbound benchmark results

| | Rosetta Dock | | | | | ITScorePP | | | | | ConvexPP | | | | |
|---|---|---|---|---|---|---|---|---|---|---|---|---|---|---|---|
| Complex | Quality | Rank | L_{RMSD} | I_{RMSD} | fₙₐₜ | Quality | Rank | L_{RMSD} | I_{RMSD} | fₙₐₜ | Quality | Rank | L_{RMSD} | I_{RMSD} | fₙₐₜ |
| 1ACB | 3 | 3 | 3.41 | 9.08 | 0.13 | 3 | 4 | 3.39 | 9.04 | 0.11 | 2 | 1 | 1.13 | 4.31 | 0.778 |
| 1A0O | 2 | 1 | 4.18 | 10.29 | 0.57 | 2 | 1 | 4.18 | 10.29 | 0.57 | 3 | 1 | 5.79 | 11.3 | 0.353 |
| 1AHW | 2 | 1 | 2.37 | 6.41 | 0.51 | 3 | 4 | 3.00 | 6.46 | 0.49 | 2 | 1 | 2.31 | 4.82 | 0.44 |
| 1ATN | 3 | 1 | 2.79 | 5.83 | 0.49 | 3 | 1 | 4.70 | 9.49 | 0.38 | 1 | 1 | 0.708 | 2.34 | 0.765 |
| 1AVW | 2 | 1 | 2.09 | 6.02 | 0.67 | 2 | 1 | 1.81 | 5.07 | 0.71 | 2 | 1 | 1.38 | 6.01 | 0.746 |
| 1AVZ | 3 | 37 | 4.05 | 8.08 | 0.29 | 3 | 22 | 5.55 | 11.47 | 0.35 | 3 | 20 | 4.41 | 8.41 | 0.122 |
| 1BQL | 1 | 1 | 0.86 | 1.57 | 0.64 | 1 | 5 | 0.72 | 1.81 | 0.65 | 1 | 1 | 0.96 | 1.4 | 0.895 |
| 1BRC | 2 | 4 | 1.21 | 3.77 | 0.75 | 2 | 1 | 1.21 | 3.77 | 0.75 | 2 | 1 | 1.62 | 7.24 | 0.759 |
| 1BRS | 2 | 1 | 1.73 | 4.78 | 0.64 | 3 | 1 | 4.46 | 8.68 | 0.33 | 3 | 1 | 3.79 | 8.7 | 0.309 |
| 1BTH | 3 | 4 | 5.54 | 18.21 | 0.30 | 3 | 2 | 2.35 | 5.60 | 0.42 | 3 | 1 | 2.67 | 5.59 | 0.44 |
| 1BVK | 3 | 1 | 3.93 | 7.91 | 0.20 | 3 | 1 | 3.54 | 7.18 | 0.20 | 3 | 1 | 3.45 | 7.75 | 0.222 |
| 1CGI | 2 | 2 | 1.86 | 3.79 | 0.50 | 3 | 8 | 2.37 | 6.01 | 0.42 | 3 | 3 | 2.11 | 6.44 | 0.376 |
| 1CHO | 3 | 1 | 2.19 | 6.31 | 0.46 | 3 | 1 | 3.76 | 10.32 | 0.18 | 2 | 1 | 1.81 | 6.35 | 0.661 |
| 1CSE | 2 | 6 | 3.12 | 10.10 | 0.56 | 2 | 1 | 2.66 | 8.81 | 0.71 | 3 | 1 | 2.29 | 7.87 | 0.4 |
| 1DFJ | 2 | 1 | 2.66 | 5.69 | 0.59 | 2 | 1 | 2.66 | 5.69 | 0.59 | 2 | 1 | 2.55 | 5.63 | 0.671 |
| 1DQJ | 3 | 1 | 3.35 | 6.71 | 0.31 | 3 | 5 | 2.12 | 5.00 | 0.34 | 3 | 1 | 6.06 | 14 | 0.379 |
| 1EFU | 3 | 44 | 3.78 | 5.98 | 0.16 | 3 | 26 | 4.21 | 7.83 | 0.10 | 3 | 20 | 4.65 | 5.9 | 0.106 |
| 1EO8 | 3 | 1 | 5.54 | 10.73 | 0.31 | 3 | 31 | 3.36 | 6.12 | 0.15 | 3 | 1 | 3.29 | 10.9 | 0.42 |
| 1FBI | 2 | 1 | 1.37 | 2.79 | 0.54 | 2 | 1 | 1.86 | 3.64 | 0.51 | 3 | 1 | 4.23 | 11 | 0.357 |
| 1FIN | 3 | 364 | 5.38 | 9.88 | 0.12 | 3 | 109 | 4.19 | 8.26 | 0.12 | 3 | 200 | 6.06 | 8.27 | 0.102 |
| 1FQ1 | 3 | 1 | 5.43 | 11.37 | 0.31 | 3 | 1 | 5.09 | 9.33 | 0.41 | 3 | 1 | 4.02 | 6.79 | 0.434 |
| 1FSS | 1 | 1 | 0.97 | 3.07 | 0.74 | 2 | 1 | 1.42 | 4.46 | 0.46 | 2 | 1 | 1.54 | 3.89 | 0.631 |
| 1GLA | 2 | 4 | 1.85 | 5.96 | 0.65 | 3 | 7 | 3.83 | 11.96 | 0.35 | 2 | 1 | 1.7 | 6.2 | 0.842 |
| 1GOT | 3 | 12 | 3.95 | 7.86 | 0.19 | 3 | 4 | 4.26 | 9.71 | 0.19 | 3 | 2 | 3.21 | 12.9 | 0.173 |
| 1IAI | 3 | 8 | 3.42 | 6.60 | 0.22 | 2 | 1 | 1.61 | 4.18 | 0.62 | 2 | 1 | 1.62 | 3.82 | 0.333 |
| 1IGC | 1 | 1 | 0.63 | 2.15 | 0.85 | 1 | 1 | 0.63 | 2.15 | 0.85 | 1 | 1 | 0.561 | 1.92 | 1 |
| 1JHL | 3 | 3 | 4.51 | 8.56 | 0.26 | 2 | 2 | 2.66 | 6.09 | 0.56 | 3 | 2 | 3.94 | 7.65 | 0.308 |
| 1MAH | 2 | 1 | 1.19 | 3.72 | 0.70 | 3 | 1 | 2.77 | 8.66 | 0.26 | 2 | 1 | 1.15 | 3.71 | 0.778 |
| 1MDA | 3 | 1 | 3.59 | 8.77 | 0.19 | 3 | 1 | 3.92 | 9.84 | 0.26 | 2 | 2 | 2.38 | 6.65 | 0.524 |
| MEL | 2 | 1 | 2.62 | 8.47 | 0.50 | 2 | 4 | 2.62 | 8.47 | 0.50 | 2 | 1 | 2.84 | 7.89 | 0.516 |
| 1MLC | 2 | 7 | 1.37 | 4.91 | 0.52 | 3 | 1 | 3.45 | 15.36 | 0.20 | 3 | 1 | 3.04 | 15.4 | 0.238 |
| 1NCA | 2 | 1 | 1.53 | 3.06 | 0.61 | 1 | 1 | 0.64 | 1.24 | 0.75 | 2 | 1 | 2.13 | 7.62 | 0.659 |
| 1NMB | 1 | 1 | 0.44 | 0.90 | 0.80 | 1 | 6 | 0.76 | 2.66 | 0.85 | 1 | 1 | 0.569 | 2.66 | 1 |
| 1PPE | 1 | 1 | 0.52 | 1.38 | 0.73 | 3 | 1 | 2.39 | 7.42 | 0.28 | 1 | 1 | 0.54 | 1.38 | 0.887 |
| 1QFU | 2 | 1 | 1.10 | 3.02 | 0.64 | 1 | 4 | 1.00 | 2.93 | 0.69 | 1 | 1 | 0.982 | 3.89 | 0.673 |
| 1SPB | 1 | 1 | 0.62 | 1.06 | 0.68 | 1 | 1 | 0.70 | 1.47 | 0.69 | 1 | 1 | 0.538 | 1.04 | 0.819 |
| 1STF | 1 | 1 | 0.68 | 1.91 | 0.89 | 1 | 2 | 0.54 | 1.57 | 0.91 | 1 | 1 | 0.514 | 1.57 | 0.944 |
| 1TAB | 2 | 1 | 1.30 | 4.16 | 0.74 | 2 | 1 | 1.37 | 4.39 | 0.76 | 2 | 1 | 1.47 | 4.11 | 0.677 |
| 1TGS | 2 | 1 | 1.44 | 2.48 | 0.59 | 2 | 1 | 1.38 | 2.26 | 0.64 | 3 | 1 | 3.55 | 8.41 | 0.438 |
| 1UDI | 2 | 1 | 1.43 | 3.35 | 0.63 | 2 | 1 | 1.01 | 2.08 | 0.74 | 2 | 1 | 1.09 | 2.08 | 0.707 |
| 1UGH | 1 | 1 | 0.86 | 1.78 | 0.67 | 2 | 1 | 1.90 | 4.64 | 0.46 | 2 | 1 | 1.96 | 4.61 | 0.598 |
| 1WEJ | 3 | 15 | 2.92 | 9.28 | 0.44 | 2 | 2 | 2.55 | 6.90 | 0.62 | 3 | 1 | 4.79 | 9.37 | 0.227 |
| 1WQ1 | 3 | 1 | 2.46 | 5.53 | 0.34 | 2 | 1 | 1.92 | 3.38 | 0.39 | 2 | 2 | 1.59 | 3.83 | 0.582 |
| 2BTF | 3 | 1 | 3.23 | 10.03 | 0.22 | 1 | 1 | 0.60 | 1.52 | 0.75 | 1 | 1 | 0.598 | 1.31 | 0.897 |
| 2JEL | 2 | 1 | 2.22 | 4.82 | 0.52 | 2 | 1 | 1.98 | 6.55 | 0.65 | 2 | 1 | 1.26 | 6.42 | 0.857 |
| 2KAI | 1 | 2 | 0.97 | 2.02 | 0.67 | 2 | 2 | 1.05 | 2.48 | 0.70 | 1 | 8 | 0.892 | 2.26 | 0.882 |
| 2PCC | 3 | 2 | 3.39 | 9.19 | 0.24 | 3 | 1 | 3.84 | 9.38 | 0.29 | 3 | 1 | 4.31 | 9.4 | 0.483 |
| 2PTC | 1 | 4 | 0.44 | 0.82 | 0.80 | 2 | 4 | 1.82 | 5.86 | 0.70 | 2 | 1 | 1.16 | 5.3 | 0.735 |
| 2SIC | 2 | 1 | 1.53 | 5.18 | 0.85 | 2 | 1 | 1.53 | 5.18 | 0.85 | 1 | 1 | 0.956 | 4.84 | 0.817 |
| 2SNI | 2 | 1 | 2.01 | 6.70 | 0.60 | 1 | 1 | 0.99 | 2.88 | 0.73 | 2 | 1 | 2 | 7.38 | 0.606 |
| 2TEC | 1 | 1 | 0.81 | 2.46 | 0.74 | 1 | 1 | 0.85 | 2.59 | 0.78 | 1 | 1 | 0.591 | 1.97 | 0.8 |
| 2VIR | 3 | 1 | 4.19 | 7.53 | 0.26 | 2 | 2 | 2.17 | 5.74 | 0.70 | 2 | 1 | 1.03 | 5.78 | 0.673 |
| 3HHR | 3 | 50 | 3.95 | 9.84 | 0.26 | 3 | 3 | 4.03 | 8.17 | 0.30 | 3 | 1 | 3.47 | 9.41 | 0.329 |
| 4HTC | 2 | 1 | 1.54 | 3.81 | 0.61 | 3 | 1 | 2.25 | 5.95 | 0.42 | 2 | 1 | 1.5 | 4.04 | 0.76 |

| | | |
|---|---|---|
| Top 1: 66.7% (36/54) | Top 1: 59.3% (32/54) | Top 1: 83.3% (45/54) |
| Rank 1 and Quality 1: | Rank 1 and Quality 1: | Rank 1 and Quality 1: |
| 14.8% (8/54) | 11.1% (6/54) | 20.4% (11/54) |
| Rank 1 and Quality 1 \|\| 2: | Rank 1 and Quality 1 \|\| 2: | Rank 1 and Quality 1 \|\| 2: |
| 46.2% (25/54) | 42.6% (23/54) | 57.4% (31/54) |
| Rank <10 and Quality 1\|\| 2: | Rank <10 and Quality 1\|\| 2: | Rank <10 and Quality 1\|\| 2: |
| 61.1% (33/54) | 57.4% (31/54) | 63.0% (34/54) |

### EMBODIMENT 1

A method for modeling the geometric structure of the interface of Receptor-Ligand complexes, wherein a first chemical molecule defined as Receptor and a second chemical molecule defined as Ligand, wherein said method comprises the following steps wherein at least one of them is implemented or assisted by computer:

(a) providing a set of Receptors and Ligands from at least one computer database, wherein Receptor-Ligand complexes present an interface comprising different atom types, wherein atom type k is located on the Receptor and atom type I is located on the Ligand interact, k and I varying depending on the atom type;

(b) selecting atoms from at the Receptor-Ligand complexes interface of said Receptors and Ligands;

(c) assigning to each selected atoms an atom type among k and I;

(d) providing for Receptor-Ligand complexes the distances rᵢⱼ between an atom i of a specific atom type k of the Receptor and an atom j of a specific atom type I of the Ligand, wherein i index runs over specific atoms among atom type k, and wherein j index runs over specific atoms among atom type I;

(e) optionally repeating step (c) for all or other atoms types k and I;

(f) assigning the distances rᵢⱼ as a function of atom types; and

(g) providing the modeling of the geometric structure of the interface of Receptor-Ligand complexes as a function of distances rᵢⱼ.

### EMBODIMENT 2

The method of embodiment 1, wherein said modeling of the geometric structure of the interface of Receptor-Ligand complexes takes into account inaccuracies in the determination of distances rᵢⱼ.

### EMBODIMENT 3

The method of embodiment 1, wherein the modeling of the geometric structure of the interface of Receptor-Ligand complexes as a function of distances rᵢⱼ. is defined by the number densities n^{kl}(r), wherein said number densities n^{kl}(r) is defined as:

$${n}^{kl} ( r ) = {\sum }_{ij} \frac{1}{\sqrt{2 π {σ}^{2}}} {e}^{- \frac{{( r - {r}_{ij} )}^{2}}{2 {σ}^{2}}} , \qquad ( 4 )$$

wherein each distance distribution is represented by a Gaussian centered at rᵢⱼ with the constant variance of σ⁻², and wherein the distance rᵢⱼ is smaller than a determined cutoff distance rₘₐₓ.

### EMBODIMENT 4

A method for generating virtual Non-Native Receptor-Ligand complexes, wherein said method comprises the following steps wherein at least one of them is implemented or assisted by computer:

(a) providing a set of Native Receptor-Ligand complexes Pᵢ^{nat} from at least one computer database, wherein Receptor-Ligand complexes present an interface wherein site k of the Receptor and site I of the Ligand interact;

(b) generating D Non-Native Receptor-Ligand complexes Pⱼ^{nonnat}, j=1 . . . D wherein j index runs over generated decoys and D represents the total number of Non-Native Receptor-Ligand complexes generated, wherein Non-Native Receptor-Ligand complexes are generated by moving spatially the Ligand relative to the Receptor or by local deformation along spatial directions from the Native Receptor-Ligand complexes.

### EMBODIMENT 5

The method of embodiment 4, wherein Non-Native Receptor-Ligand complexes Pⱼ^{nonnat} are generated by rolling the Ligand over the surface of the Receptor.

### EMBODIMENT 6

The method of embodiment 4, wherein Non-Native Receptor-Ligand complexes Pⱼ^{nonnat} are generated by the following steps:
Considering a Ligand as a rigid body,
Rotating the Ligand about one or more rotational axes, and
Translating the Ligand along the coordinate axes.

### EMBODIMENT 7

The method of embodiment 6, wherein Non-Native Receptor-Ligand complexes Pⱼ^{nonnat} are generated by linear combinations of modes {vᵢ} as follows:

$${X}^{decoy} = {X}^{native} + \sqrt{{k}_{B} T} {\sum }_{i = 6}^{15} {r}_{i} \frac{{v}_{i}}{{ω}_{i}} ,$$

where X^{native} and X^{decoy} are the coordinate vectors corresponding to the native and non-native conformations, respectively, r, is the random weight for each mode ranging from −1 to 1, and ωᵢ is the frequency of the mode vᵢ.

### EMBODIMENT 8

A method for modeling the interaction between a Receptor and a Ligand in Receptor-Ligand complexes, wherein said method comprises the following steps wherein at least one of them is implemented or assisted by computer:

(a) providing a set of Receptors and Ligands from at least one computer database;

(b) assigning to each Receptor-Ligand complex a specific structure vector x which is a mathematical vector representing the specific geometric structure of the interface between a Receptor and a Ligand in a specific Receptor-Ligand complex;

(c) computing a linear convex scoring function F as a function of all specific structure vectors x or of vector X which is the concatenation of all vectors x thereof, preferably said linear convex scoring function F being also a function of a scoring vector w;

(d) projecting said scoring function F in orthogonal polynomial subspaces; thereby modeling the interaction between a Receptor and a Ligand in Receptor-Ligand complexes.

### EMBODIMENT 9

A method for determining a scoring vector w which is a mathematical vector quantifying and/or qualifying the interaction of a geometric structure of the interface of a Receptor-Ligand complex, wherein Receptor-Ligand complexes present an interface in interaction, wherein said interaction is in need for quantification and/or qualification, wherein said method comprises the following steps wherein at least one of them is implemented or assisted by computer:

(a) providing a set of Receptors and Ligands from at least one computer database;

(b) assigning to each geometric structure of an interface of a Receptor-Ligand complex, a specific structure vector x which is a mathematical vector representing the specific geometric structure of the interface;

(c) computing a linear convex scoring function F as a function of all specific structure vectors x and scoring vector w;

(e) projecting said scoring function F in orthogonal polynomial subspaces;

(f) formulating a convex optimization problem;

(g) solving the convex optimization problem thereby determining a scoring vector w.

### EMBODIMENT 10

The method of embodiment 9, wherein said step (a) comprises providing Native Receptor-Ligand complex Pᵢ^{nat} and Non-native Receptor-Ligand complexes Pᵢⱼ^{nonnat}, wherein i index runs over different protein complexes.

### EMBODIMENT 11

The method of embodiment 9, wherein said step (b) comprises implementing a method as defined by any one of embodiments 1 to 3.

### EMBODIMENT 12

The method of embodiment 9, wherein in step (e) orthogonal polynomial subspaces are Rectangular, Legendre, Laguerre or Fourier orthogonal bases.

### EMBODIMENT 13

The method of embodiment 9, wherein step (f) comprises using the artificially generated noise applied to the original input data wherein said noise is represented by the Gaussian distance distribution of the input data having a variance σ where σ is constant and does not depend on the atom type, and can be thought as a Gaussian filter applied to the input data if the latter is represented as a 1D signal.

### EMBODIMENT 14

The method of embodiment 9, wherein step (f) comprises formulating a convex optimization problem so as to minimize the convex function.

### EMBODIMENT 15

The method of any one of embodiments 9 to 14, wherein said method further comprises finding the scoring vector w.

### EMBODIMENT 16

A method for determining the binding affinity or binding free energy of a position of a Ligand relative to a Receptor in one or more Receptor-Ligand complexes, wherein said Receptor-Ligand complex presents an interface comprising different atom types, wherein atom type k, located on the Receptor, and atom type I, located on the Ligand, interact, k and I varying depending on the atom type, wherein said method comprises the following steps wherein at least one of them is implemented or assisted by computer:

(i) modeling the geometric structure of the interface of one or more Receptor-Ligand complexes, said modeling being as defined in any one of embodiments 1 to 7

(ii) assigning to a geometric structure of the interface of Receptor-Ligand complex, a binding affinity or binding free energy by reference to a database, optionally wherein said binding affinity or binding free energy is determined as a scalar product of the structure vector x with the scoring vector w as defined in the method of embodiment 9.

### EMBODIMENT 17

A method for ranking the binding affinity or binding free energy of spatial positions of a Ligand relative to a Receptor in one or more Receptor-Ligand complexes, wherein said method comprises the following steps wherein at least one of them is implemented or assisted by computer:

(i) implementing the method of embodiment 16 to determine the binding affinity or binding free energy of two or more spatial positions of a Ligand relative to a Receptor in one or more Receptor-Ligand complexes,

(ii) ranking spatial positions of a Ligand relative to a Receptor based on said binding affinity or binding free energy by providing a strict relationship between a set of spatial positions such that, for any two positions, the first is either ranked higher, lower or equal to the second position if the binding energy of the first position is smaller, equal or higher than the energy of the second position, respectively.

### EMBODIMENT 18

The method of embodiment 17, wherein the best spatial position of a Ligand relative to a Receptor in one or more Receptor-Ligand complexes is determined based on the ranking of said binding affinity or binding free energy.

### EMBODIMENT 19

The method of embodiment 17, wherein the best binding affinity or free binding energy among several Receptor-Ligand complexes is determined based on the ranking of said binding affinity or binding free energy.

### BIBLIOGRAPHY

1. Cheng, T., Li, X., Li, Y., Liu, Z., & Wang, R. 2009, Journal of Chemical Information and Modeling, 49, 1079-1093.
2. Rarey, M., Kramer, B., Lengauer, T., & Klebe, G. 1996, Journal of Molecular Biology, 261, 470-489.
3. Tanaka, S. & Scheraga, H. A. 1976, Macromolecules, 9, 945-950.
4. Miyazawa, S. & Jernigan, R. L. 1985, Macromolecules, 18, 534-552.
5. Sippl, M. J. 1990, Journal of Molecular Biology, 213, 859-883.
6. Clark, M., Cramer, R. D., & Van Opdenbosch, N. 1989, Journal of Computational Chemistry, 10, 982-1012.
7. Neudert, G. & Klebe, G. 2011, Bioinformatics (Oxford, England), 27, 1021.
8. Ritchie, D. W. & Kemp, G. J. L. 2000, Proteins: Structure, Function, and Bioinformatics, 39, 178-194.
9. OLBoyle, N. M., Banck, M., James, C. A., Morley, C., Vandermeersch, T., & Hutchison, G. R. 2011, Journal of Cheminformatics, 3, 33.
10. Vapnik, V. 1999, The nature of statistical learning theory.
11. Cortes, C. & Vapnik, V. 1995, Machine Learning, 20, 273-297.
12. Burges, C. J. C. & Crisp, D. J. 2000, in Advances in Neural Information Processing Systems, Vol. 12, 223-229.
13. Huang, S. Y. & Zou, X. 2008, Proteins: Structure, Function, and Bioinformatics, 72, 557-579.
14. Wang, R., Fang, X., Lu, Y., & Wang, S. 2004, Journal of Medicinal Chemistry, 47, 2977-2980.
15. Berman, H. M., Westbrook, J., Feng, Z., Gilliland, G., Bhat, T., Weissig, H., Shindyalov, I. N., & Bourne, P. E. 2000, Nucleic Acids Research, 28, 235-242.
16. Neudert, G. & Klebe, G. 2011, Journal of Chemical Information and Modeling, 51, 2731-45.
17. Hwang, H., Pierce, B., Mintseris, J., Janin, J., & Weng, Z. 2008, Proteins: Structure, Function, and Bioinformatics, 73, 705-709.
18. Chen, R. & Weng, Z. 2002, Proteins: Structure, Function, and Bioinformatics, 47, 281-294.
19. Gray, J. J., Moughon, S., Wang, C., Schueler-Furman, O., Kuhlman, B., Rohl, C. A., & Baker, D. 2003, Journal of Molecular Biology, 331, 281-300.
20. Méndez, R., Leplae, R., De Maria, L., & Wodak, S. J. 2003, Proteins: Structure, Function, and Bioinformatics, 52, 51-67.

1. A method for determining a scoring vector effective to quantify and qualify an interaction of a geometric structure of an interface of a Receptor-Ligand complex, wherein Receptor-Ligand complexes present an interface in interaction, the interaction is in need for quantification and/or qualification, the method comprising:
providing a set of Receptors and Ligands from at least one computer database;
assigning to each geometric structure of an interface of a Receptor-Ligand complex, a specific structure vector, wherein the specific structure vector is effective to represent the specific geometric structure of the interface;
computing a linear convex scoring function, wherein the linear convex scoring function is a function of all specific structure vectors and the scoring vector;
projecting the linear convex scoring function in orthogonal polynomial subspaces;
formulating a convex optimization problem;
solving the convex optimization problem in order to determine the scoring vector.

2. The method of claim 1, wherein providing a set of Receptors and Ligands comprises providing Native Receptor-Ligand complex and Non-native Receptor-Ligand complexes wherein an index of the Native Receptor-Ligand complex and the Non-native Receptor-Ligand complexes runs over different protein complexes.

3. The method of claim 1, wherein in the Receptor-Ligand complexes present an interface comprising different atom types, wherein a first atom type is located on the Receptor and a second atom type is located on the Ligand interact, wherein values of the first and second atom types vary based on the atom type, and wherein assigning to each geometric structure of an interface of a Receptor-Ligand complex comprises implementing a method for modeling the geometric structure of the interface of the Receptor-Ligand complexes, wherein a first chemical molecule is defined as the Receptor and a second chemical molecule is defined as the Ligand, the method further comprising:
selecting atoms from the Receptor-Ligand complexes interface of said Receptors and Ligands;
assigning to each selected atoms an atom type among the first and second atom types;
providing for Receptor-Ligand complexes a set of distances between a first atom of a specific atom type of the Receptor and a second atom of a specific atom type of the Ligand, wherein a first index of the set of distances runs over specific atoms among the first atom type, and wherein a second index of the set of distances runs over specific atoms among the second atom type;
repeating the assignment of atom types to each selected atoms for all or other atoms types;
assigning the set of distances as a function of atom types; and
providing the modeling of the geometric structure of the interface of Receptor-Ligand complexes as a function of the set of distances.

4. The method of claim 3, wherein modeling of the geometric structure of the interface of Receptor-Ligand complexes is based on inaccuracies in the determination of the set of distances.

5. The method of claim 3, wherein the modeling of the geometric structure of the interface of Receptor-Ligand complexes as a function of the set of distances is defined by a number of densities wherein the number densities is a Gaussian distribution centered at the set of distances with a constant variance, and wherein the set of distances is smaller than a determined cutoff distance.

6. The method of claim 1, wherein the orthogonal polynomial subspaces include Rectangular, Legendre, Laguerre or Fourier orthogonal bases.

7. The method of claim 1, wherein formulating the convex optimization problem comprises using an artificially generated noise applied to input data, wherein the artificially generated noise is represented by a Gaussian distance distribution of the input data including a variance, wherein the variance is constant and does not depend on an atom type, and the variance relates to a Gaussian filter applied to the input data if the latter is represented as a 1D signal.

8. The method of claim 1, wherein formulating the convex optimization problem comprises formulating a convex optimization problem so as to minimize the convex function.

9. The method of claim 1, further comprises determining the scoring vector.
